(19) United States
(12) Patent Application Publication
(10) Pub. No.: US 2025/0034296 A1
(43) Pub. Date: Jan. 30, 2025

(54) UV CURABLE PRINTABLE FORMULATIONS FOR POROSITY CONTROL IN HIGH PERFORMANCE CHEMICAL MECHANICAL POLISHING PADS

(71) Applicant: Applied Materials, Inc., Santa Clara, CA (US)

(72) Inventors: Xinyi LU, Santa Clara, CA (US); Srikant PATHAK, Diamond Bar, CA (US); Sudhakar MADHUSOODHANAN, Pleasanton, CA (US)

(21) Appl. No.: 18/226,962

(22) Filed: Jul. 27, 2023

(51) Int. Cl. C08F 20/56; B24B 37/22; B24B 37/24; C08L 39/06

(52) U.S. Cl. CPC C08F 20/56; B24B 37/22; B24B 37/24; C08L 39/06

(57) ABSTRACT

Polishing pads having porogen-features, methods of manufacturing polishing pads having porogen features, and compositions for manufacturing polishing pads having porogen features, and more particularly, to polishing pads used for chemical mechanical polishing (CMP) of a substrate in electronic device processing are provided. In one aspect, the porogen-forming composition, in proportions based on a total weight of the porogen-forming composition, includes (A) from about 60 to about 80 wt. % of an acrylamide monomer compound selected from acryloylmorpholine, N, N-dimethylacrylamide, or a combination thereof. The curable porogen-forming composition further includes (B) from about 10 to about 40 wt. % of a polyhydroxy compound having two or more hydroxyl groups. The curable porogen-forming composition further includes (C) from about 0.2 wt. % to about 4 wt. % of a photoinitiator component.

### TECHNICAL FIELD

The present disclosure generally relates to polishing pads, methods of manufacturing polishing pads, and formulations for manufacturing polishing pads, and more particularly, to polishing pads used for chemical mechanical polishing (CMP) of a substrate in electronic device processing.

### BACKGROUND

CMP is used in the manufacturing of high-density integrated circuits to planarize or polish a layer of material deposited on a substrate. A CMP process includes contacting the material layer to be planarized with a polishing pad and moving the polishing pad, the substrate, or both, to create relative movement between the material layer surface and the polishing pad, in the presence of a polishing fluid including abrasive particles, chemically active components, or both.

One common application of a CMP process in semiconductor device manufacturing is planarization of a bulk film, for example pre-metal dielectric (PMD) or interlayer dielectric (ILD) polishing, where underlying two or three-dimensional features create recesses and protrusions in the to be planarized material surface. Other common applications of CMP processes in semiconductor device manufacturing include shallow trench isolation (STI) and interlayer metal interconnect formation, where the CMP process is used to remove the via, contact, or trench fill material (overburden) from the exposed surface (field) of the material layer having the STI or metal interconnect features disposed therein.

Often, polishing pads used in CMP processes are selected based on material properties of the polishing pad and the suitability of those material properties for the targeted CMP application. One example material property that affects the performance of a polishing pad for a targeted CMP application is the storage modulus of the polishing layer. Generally, polishing pads formed of comparatively harder materials provide superior local planarization performance when compared to polishing pads formed of softer materials. However, polishing pads formed of harder materials are also associated with increased defectivity, such as undesirable scratches in a substrate surface, when compared with softer polishing pads. Unfortunately, conventional polishing pads soften at high temperatures, thus reducing their ability to maintain desirable hardness over a wide temperature range.

Accordingly, there is a need in the art for polishing pads that maintain their material properties and provide stable performance over a wide temperature range.

### SUMMARY

The present disclosure generally relates to polishing pads, methods of manufacturing polishing pads, and formulations for manufacturing polishing pads, and more particularly, to polishing pads used for chemical mechanical polishing (CMP) of a substrate in electronic device processing.

In one aspect, a curable porogen-forming composition is provided. The curable porogen-forming composition is used in forming removable porogen-features when producing a photochemically fabricated polishing article by an additive manufacturing process. The curable porogen-forming composition, in proportions based on a total weight of the curable porogen-forming composition, includes (A) from about 60 to about 80 wt. % of an acrylamide monomer compound selected from 4-acryloylmorpholine (ACMO™), N, N-dimethylacrylamide (DMAA™), or a combination thereof. The curable porogen-forming composition further includes (B) from about 10 to about 40 wt. % of a polyhydroxy compound having two or more hydroxyl groups. The curable porogen-forming composition further includes (C) from about 0.2 wt. % to about 4 wt. % of a photoinitiator component.

In another aspect, a method of forming a polishing pad is provided. The method includes sequentially forming a plurality of polymer layers. Forming the plurality of polymer layers includes forming a first layer of the polishing pad. Forming the first layer includes dispensing one or more droplets of a first pre-polymer composition via an additive manufacturing process on a surface on which the first layer is formed, dispensing one or more droplets of a curable porogen-forming composition, and at least partially curing the dispensed droplets of the first pre-polymer composition to form the first layer of the polishing pad comprising a plurality of porogen-features. The curable porogen-forming composition, in proportions based on a total weight of the curable porogen-forming composition, includes (A) from about 60 to about 80 wt. % of an acrylamide monomer compound selected from 4-acryloylmorpholine (ACMO™), N,N-dimethylacrylamide (DMAA™), or a combination thereof. The curable porogen-forming composition further includes (B) from about 10 to about 40 wt. % of a polyhydroxy compound having two or more hydroxyl groups. The curable porogen-forming composition further includes (C) from about 0.2 wt. % to about 4 wt. % of a photoinitiator component.

In yet another aspect, a polishing pad is provided. The polishing pad includes a plurality of polishing elements. Each of the polishing elements include an individual surface that forms a portion of a polishing surface of a polishing pad and one or more sidewalls extending downward from the individual surface to define a plurality of channels disposed between the polishing elements. Each of the polishing elements has a plurality of porogen-features formed from a curable porogen-forming composition. The curable porogen-forming composition, in proportions based on a total weight of the curable porogen-forming composition, includes (A) from about 60 to about 80 wt. % of an acrylamide monomer compound selected from 4-acryloylmorpholine (ACMO™), N,N-dimethylacrylamide (DMAA™), or a combination thereof. The curable porogen-forming composition further includes (B) from about 10 to about 40 wt. % of a polyhydroxy compound having two or more hydroxyl groups. The curable porogen-forming composition further includes (C) from about 0.2 wt. % to about 4 wt. % of a photoinitiator component.

In one aspect, a curable porogen-forming composition is provided. The curable porogen-forming composition is used in forming removable porogen-features when producing a photochemically fabricated polishing article by an additive manufacturing process. The curable porogen-forming composition, in proportions based on a total weight of the curable porogen-forming composition, includes (A) from about 60 to about 80 wt. % of an acrylamide monomer compound represented by the following general formula (I):

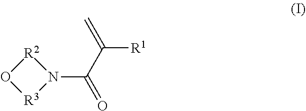

R¹ is a hydrogen or methyl group, R² and R³ are each independently and optionally substituted divalent hydrocarbon groups. The porogen-forming composition further includes (B) from about 10 to about 40 wt. % of a polyhydroxy compound having two or more hydroxyl groups. The porogen-forming composition further includes (C) from about 0.2 wt. % to about 4 wt. % of a photoinitiator component.

In another aspect, a method of forming a polishing pad is provided. The method includes sequentially forming a plurality of polymer layers. Forming the plurality of polymer layers includes forming a first layer of the polishing pad. Forming the first layer includes dispensing one or more droplets of a first pre-polymer composition via an additive manufacturing process on a surface on which the first layer is formed, dispensing one or more droplets of a curable porogen-forming composition, and at least partially curing the dispensed droplets of the first pre-polymer composition to form the first layer of the polishing pad comprising a plurality of porogen-features. The curable porogen-forming composition, in proportions based on a total weight of the curable porogen-forming composition, includes (A) from about 60 to about 80 wt. % of an acrylamide monomer compound represented by the following general formula (I):

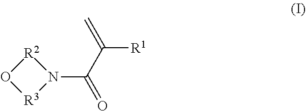

R¹ is a hydrogen or methyl group, R² and R³ are each independently and optionally substituted divalent hydrocarbon groups. The porogen-forming composition further includes (B) from about 10 to about 40 wt. % of a polyhydroxy compound having two or more hydroxyl groups. The porogen-forming composition further includes (C) from about 0.2 wt. % to about 4 wt. % of a photoinitiator component.

In yet another aspect, a polishing pad is provided. The polishing pad includes a plurality of polishing elements. Each of the polishing elements include an individual surface that forms a portion of a polishing surface of a polishing pad and one or more sidewalls extending downward from the individual surface to define a plurality of channels disposed between the polishing elements. Each of the polishing elements has a plurality of porogen-features formed from a curable porogen-forming composition. The curable porogen-forming composition, in proportions based on a total weight of the curable porogen-forming composition, includes (A) from about 60 to about 80 wt. % of an acrylamide monomer compound represented by the following general formula (I):

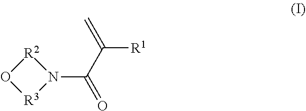

R¹ is a hydrogen or methyl group, R² and R³ are each independently and optionally substituted divalent hydrocarbon groups. The porogen-forming composition further includes (B) from about 10 to about 40 wt. % of a polyhydroxy compound having two or more hydroxyl groups. The porogen-forming composition further includes (C) from about 0.2 wt. % to about 4 wt. % of a photoinitiator component.

Implementations may include one or more of the following. The porogen-forming composition further includes (D) from about 10 wt. % to about 20 wt. % of polyvinylpyrrolidone. R¹ is a hydrogen group and R² and R³ are ethylene groups. R¹ is a methyl group and R² and R³ are ethylene groups. The polyhydroxy compound having two or more hydroxyl groups is a water-soluble polyhydroxy compound which does not possess any curable functional groups. The polyhydroxy compound having two or more hydroxyl groups has a molecular weight in a range from about 400 g/mol to about 1000 g/mol. The porogen-forming composition further includes from about 70 wt. % to about 80 wt. % of the acrylamide monomer compound and from about 10 wt. % to about 20 wt. % of the polyhydroxy compound having two or more hydroxyl groups. A polishing article formed using the curable porogen-forming composition.

In one aspect, a curable porogen-forming composition is provided. The curable porogen-forming composition is used in forming removable porogen-features when producing a photochemically fabricated polishing article by an additive manufacturing process. The curable porogen-forming composition, in proportions based on a total weight of the curable porogen-forming composition, includes (A) from about 60 to about 80 wt. % of an acrylamide monomer compound represented by the following general formula (II):

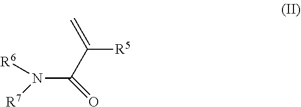

R⁵ is a hydrogen or methyl group, R⁶ and R⁷ are each independently and optionally unsubstituted hydrocarbon groups. The porogen-forming composition further includes (B) from about 10 to about 40 wt. % of a polyhydroxy compound having two or more hydroxyl groups, and (C) from about 0.2 wt. % to about 4 wt. % of a photoinitiator component.

In another aspect, a method of forming a polishing pad is provided. The method includes sequentially forming a plurality of polymer layers. Forming the plurality of polymer layers includes forming a first layer of the polishing pad. Forming the first layer includes dispensing one or more droplets of a first pre-polymer composition via an additive manufacturing process on a surface on which the first layer is formed, dispensing one or more droplets of a curable porogen-forming composition, and at least partially curing the dispensed droplets of the first pre-polymer composition to form the first layer of the polishing pad comprising a plurality of porogen-features. The curable porogen-forming composition is used in forming removable porogen-features when producing a photochemically fabricated polishing article by an additive manufacturing process. The curable porogen-forming composition, in proportions based on a total weight of the curable porogen-forming composition, includes (A) from about 60 to about 80 wt. % of an acrylamide monomer compound represented by the following general formula (II):

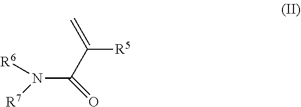

R⁵ is a hydrogen or methyl group, R⁶ and R⁷ are each independently and optionally unsubstituted hydrocarbon groups. The porogen-forming composition further includes (B) from about 10 to about 40 wt. % of a polyhydroxy compound having two or more hydroxyl groups, and (C) from about 0.2 wt. % to about 4 wt. % of a photoinitiator component.

In yet another aspect, a polishing pad is provided. The polishing pad includes a plurality of polishing elements. Each of the polishing elements include an individual surface that forms a portion of a polishing surface of a polishing pad and one or more sidewalls extending downward from the individual surface to define a plurality of channels disposed between the polishing elements. Each of the polishing elements has a plurality of porogen-features formed of a curable porogen-forming composition. The curable porogen-forming composition is used in forming removable porogen-features when producing a photochemically fabricated polishing article by an additive manufacturing process. The curable porogen-forming composition, in proportions based on a total weight of the curable porogen-forming composition, includes (A) from about 60 to about 80 wt. % of an acrylamide monomer compound represented by the following general formula (II):

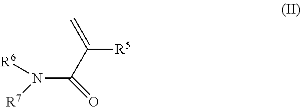

R⁵ is a hydrogen or methyl group, R⁶ and R⁷ are each independently and optionally unsubstituted hydrocarbon groups. The porogen-forming composition further includes (B) from about 10 to about 40 wt. % of a polyhydroxy compound having two or more hydroxyl groups, and (C) from about 0.2 wt. % to about 4 wt. % of a photoinitiator component.

Implementations may include one or more of the following. The porogen-forming composition further includes (D) from about 10 wt. % to about 20 wt. % of polyvinylpyrrolidone. R⁵ is a hydrogen group and R⁶ and R⁷ are methane groups. R⁵ is a methyl group and R⁶ and R⁷ are ethane groups. The polyhydroxy compound has two or more hydroxyl groups is a water soluble polyhydroxy compound which does not possess any curable functional groups. The polyhydroxy compound has two or more hydroxyl groups has a molecular weight in a range from about 400 g/mol to about 1000 g/mol. The porogen-forming composition further includes from about 70 wt. % to about 80 wt. % of the acrylamide monomer compound and from about 10 wt. % to about 20 wt. % of the polyhydroxy compound having two or more hydroxyl groups.

In one aspect, a curable porogen-forming composition is provided. The curable porogen-forming composition is used in forming removable porogen-features when producing a photochemically fabricated polishing article by an additive manufacturing process. The curable porogen-forming composition, in proportions based on a total weight of the curable porogen-forming composition, includes (A) from about 10 wt. % to about 20 wt. % of one or more difunctional water-soluble acrylate oligomer compounds, (B) from about 10 wt. % to about 30 wt. % of one or more monofunctional (meth)acrylate compounds, (C) from about 50 wt. % to about 70 wt. % of a polyhydroxy compound having two or more hydroxyl groups, and (D) from about 0.2 wt. % to about 4 wt. % of a photoinitiator component.

In another aspect, a method of forming a polishing pad is provided. The method includes sequentially forming a plurality of polymer layers. Forming the plurality of polymer layers includes forming a first layer of the polishing pad. Forming the first layer includes dispensing one or more droplets of a first pre-polymer composition via an additive manufacturing process on a surface on which the first layer is formed, dispensing one or more droplets of a curable porogen-forming composition, and at least partially curing the dispensed droplets of the first pre-polymer composition to form the first layer of the polishing pad comprising a plurality of porogen-features. The curable porogen-forming composition is used in forming removable porogen-features when producing a photochemically fabricated polishing article by an additive manufacturing process. The curable porogen-forming composition, in proportions based on a total weight of the curable porogen-forming composition, includes (A) from about 10 wt. % to about 20 wt. % of one or more difunctional water-soluble acrylate oligomer compounds, (B) from about 10 wt. % to about 30 wt. % of one or more monofunctional (meth)acrylate compounds, (C) from about 50 wt. % to about 70 wt. % of a polyhydroxy compound having two or more hydroxyl groups, and (D) from about 0.2 wt. % to about 4 wt. % of a photoinitiator component.

In yet another aspect, a polishing pad is provided. The polishing pad includes a plurality of polishing elements. Each of the polishing elements include an individual surface that forms a portion of a polishing surface of a polishing pad and one or more sidewalls extending downward from the individual surface to define a plurality of channels disposed between the polishing elements. Each of the polishing elements has a plurality of porogen-features formed of a curable porogen-forming composition. The curable porogen-forming composition is used in forming removable porogen-features when producing a photochemically fabricated polishing article by an additive manufacturing process. The curable porogen-forming composition, in proportions based on a total weight of the curable porogen-forming composition, includes (A) from about 10 wt. % to about 20 wt. % of one or more difunctional water-soluble acrylate oligomer compounds, (B) from about 10 wt. % to about 30 wt. % of one or more monofunctional (meth)acrylate compounds, (C) from about 50 wt. % to about 70 wt. % of a polyhydroxy compound having two or more hydroxyl groups, and (D) from about 0.2 wt. % to about 4 wt. % of a photoinitiator component.

Implementations may include one or more of the following. The one or more difunctional water-soluble acrylate oligomer compounds comprise a water-soluble aliphatic alkyl epoxy difunctional acrylate oligomer having a viscosity at 25° C. of 1500 cPs and a molecular weight of 750. The one or more monofunctional meth (acrylate) compounds comprise one or more methoxy polyethylene glycol monoacrylate having a molecular weight in a range from about 400 g/mol to about 600 g/mol. The polyhydroxy compound having two or more hydroxyl groups comprises a water-soluble polyhydroxy compound which does not possess any curable functional groups. The water-soluble polyhydroxy compound has two or more hydroxyl groups has a molecular weight in a range from about 400 g/mol to about 600 g/mol. The porogen-forming composition further includes acrylamide monomer compounds selected from 4-acryloylmorpholine (ACMO™), N,N-dimethylacrylamide (DMAA™), or a combination thereof. The polyhydroxy compound having two or more hydroxyl groups further includes diethylene glycol, glycerol, or a combination thereof.

In one aspect, a curable porogen-forming composition is provided. The curable porogen-forming composition is used in forming removable porogen-features when producing a photochemically fabricated polishing article by an additive manufacturing process. The curable porogen-forming composition, in proportions based on a total weight of the curable porogen-forming composition, includes (A) from about 10 wt. % to about 20 wt. % of one or more ethoxylated acrylate monomer compounds, (B) from about 10 wt. % to about 30 wt. % of one or more monofunctional (meth)acrylate compounds, (C) from about 50 wt. % to about 70 wt. % of one or more polyhydroxy compounds having two or more hydroxyl groups, and (D) from about 0.2 wt. % to about 4 wt. % of a photoinitiator component.

In another aspect, a method of forming a polishing pad is provided. The method includes sequentially forming a plurality of polymer layers. Forming the plurality of polymer layers includes forming a first layer of the polishing pad. Forming the first layer includes dispensing one or more droplets of a first pre-polymer composition via an additive manufacturing process on a surface on which the first layer is formed, dispensing one or more droplets of a curable porogen-forming composition, and at least partially curing the dispensed droplets of the first pre-polymer composition to form the first layer of the polishing pad comprising a plurality of porogen-features. The curable porogen-forming composition is used in forming removable porogen-features when producing a photochemically fabricated polishing article by an additive manufacturing process. The curable porogen-forming composition, in proportions based on a total weight of the curable porogen-forming composition, includes (A) from about 10 wt. % to about 20 wt. % of one or more ethoxylated acrylate monomer compounds, (B) from about 10 wt. % to about 30 wt. % of one or more monofunctional (meth)acrylate compounds, (C) from about 50 wt. % to about 70 wt. % of one or more polyhydroxy compounds having two or more hydroxyl groups, and (D) from about 0.2 wt. % to about 4 wt. % of a photoinitiator component.

In yet another aspect, a polishing pad is provided. The polishing pad includes a plurality of polishing elements. Each of the polishing elements include an individual surface that forms a portion of a polishing surface of a polishing pad and one or more sidewalls extending downward from the individual surface to define a plurality of channels disposed between the polishing elements. Each of the polishing elements has a plurality of porogen-features formed of a curable porogen-forming composition. The curable porogen-forming composition is used in forming removable porogen-features when producing a photochemically fabricated polishing article by an additive manufacturing process. The curable porogen-forming composition, in proportions based on a total weight of the curable porogen-forming composition, includes (A) from about 10 wt. % to about 20 wt. % of one or more ethoxylated acrylate monomer compounds, (B) from about 10 wt. % to about 30 wt. % of one or more monofunctional (meth)acrylate compounds, (C) from about 50 wt. % to about 70 wt. % of one or more polyhydroxy compounds having two or more hydroxyl groups, and (D) from about 0.2 wt. % to about 4 wt. % of a photoinitiator component.

Implementations may include one or more of the following. The one or more ethoxylated acrylate monomer compounds comprise an ethoxylated diacrylate monomer compound. The one or more ethoxylated acrylate monomer compounds comprise an ethoxylated (30) Bisphenol A diacrylate monomer having a functionality of two, a viscosity at 25° C. of 680 cPs, a molecular weight of 1658 g/mol, and a T (g° C.), by DSC, of −42. The polyhydroxy compound having two or more hydroxyl groups comprises a water-soluble polyhydroxy compound which does not possess any curable functional groups. The water-soluble polyhydroxy compound has two or more hydroxyl groups has a molecular weight in a range from about 400 g/mol to about 1000 g/mol. The polyhydroxy compound having two or more hydroxyl groups further comprises propylene glycol, glycerol, or a combination thereof. The porogen-forming composition further includes propylene carbonate.

In another aspect, a non-transitory computer readable medium has stored thereon instructions, which, when executed by a processor, causes the process to perform operations of the above method.

### BRIEF DESCRIPTION OF THE DRAWINGS

So that the manner in which the above-recited features of the present disclosure can be understood in detail, a more particular description of the aspects, briefly summarized above, may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1 is a schematic sectional view illustrating local planarization of a portion of a substrate following a chemical mechanical polishing (CMP) process using a conventional polishing pad.

FIG. 2 is a schematic side view of an exemplary polishing system configured to use a polishing pad formed in accordance with one or more implementations of the present disclosure.

FIG. 3 is a schematic isometric sectional view of a polishing pad, which may be formed using the methods described in accordance with one or more implementations of the present disclosure.

FIG. 4 is a schematic isometric view of a polishing pad in accordance with one or more implementations of the present disclosure.

FIGS. 5A-5F are schematic plan views of various polishing pad designs which may be used in place of the pad design shown in FIG. 4 in accordance with one or more implementations of the present disclosure.

FIG. 6A is a schematic sectional view of an additive manufacturing system, which may be used to form the polishing pads described in accordance with one or more implementations of the present disclosure.

FIG. 6B is a close-up cross-sectional view schematically illustrating a droplet disposed on a surface of a previously formed print layer in accordance with one or more implementations of the present disclosure.

FIG. 7 is a flow chart setting forth a method of forming a polishing pad in accordance with one or more implementations of the present disclosure.

To facilitate understanding, identical reference numerals have been used, where possible, to designate identical elements that are common to the figures. It is contemplated that elements and features of one implementation may be beneficially incorporated in other implementations without further recitation.

### DETAILED DESCRIPTION

The present disclosure generally relates to polishing pads, and methods of manufacturing polishing pads, and more particularly, to polishing pads used for chemical mechanical polishing (CMP) of a substrate in electronic device processing.

Porosity of a CMP pad plays a role during the CMP polishing process with regard to slurry transport and material removal. Porosity has an impact on material removal rate, removal profile, and other polishing attributes. Traditional polishing pads are generally formed by casting and use micro-balloons to generate porosity. Additive manufacturing of pads, for example, 3D printing, may be used to form polishing pads. Additive manufacturing processes may use liquid porogens to form pores. The liquid porogens are printed along with the structural portions of the polishing pad to form liquid porogen-features in the pad structure. During the polishing process, as portions of the polishing pad are removed, these liquid porogen-features dissolve upon exposure to water and/or aqueous polishing slurries to generate pores in the pad structure. Although, liquid porogen-features are easily removable from the polishing pad to form pores, liquid porogen-features present several challenges. For example, liquid porogen-features can decrease pad integrity. Since liquid porogen-features generally lack the structure to provide structural support to the polishing pad, pad properties such as hardness, strength, and pad wear rate can be adversely affected by the use of liquid porogens. In addition, liquid porogens can leak into adjacent curable resin materials, which form the structural portions of the polishing pad, further adversely affecting pad integrity. Thus, there is a need for improved porogen-features, polishing pads incorporating the improved porogen-features, and additive manufacturing processes for forming polishing pads incorporating the improved porogen-features. The improved porogen formulations should be jettable. The porogen-features formed by the improved porogen formulations should have sufficient integrity to maintain the structural integrity of the polishing pad during the polishing process while also being easily removable from the polishing pad during the polishing process to form pores.

In one or more implementations of the present disclosure, formulations for forming improved porogen-features, polishing pads incorporating the improved porogen-features, methods of manufacturing polishing pads incorporating the improved porogen-features, and methods of using the polishing pads incorporating the improved porogen-features are provided. The improved porogen-features can be formed using additive manufacturing processes, for example, 3D-printing, and cured during formation of the polishing pad. The improved porogen-features have structural integrity that is greater than the structural integrity provided by currently available liquid porogens. In one or more implementations, the improved porogen-features are a solid having a non-tacky surface. Tacky surfaces of the porogen-features can make the porogen-features difficult to remove from the formed polishing pad. In addition, tacky surfaces of the porogen-features can lead to packaging and handling difficulties. In one or more implementations, the improved porogen-features are water-soluble and thus can be easily removed from the polishing pad during the polishing process. The improved porogen-features can be removed from the polishing pad via exposure to water-based composition, for example, a water jet spray and/or water-based polishing formulation, mechanical abrasion, for example, via pad conditioning, or exposure to both a water-based composition and mechanical abrasion. Thus, the improved porogen-features described herein provide lower pad wear rate and improved profile, but can be easily removed from the formed polishing pad during polishing at a rate to ensure pad surface roughness and material removal rate.

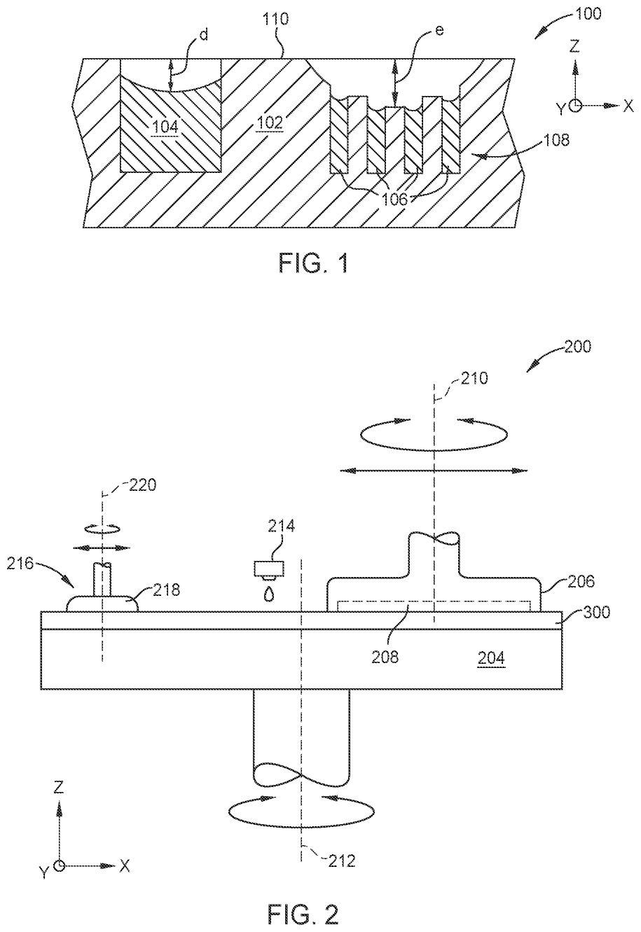

Undesirably poor local planarization performance typically associated with conventional polishing pads formed of relatively softer materials is schematically illustrated in FIG. 1. FIG. 1 is a schematic sectional view illustrating poor local planarization, for example, erosion to a distance “e” and dishing to a distance “d”, following a CMP process to remove an overburden of metal fill material from the field, for example, upper or outer, surface of a substrate 100. Here, the substrate 100 features a dielectric layer 102, a first metal interconnect feature 104 formed in the dielectric layer 102, and a plurality of second metal interconnect features 106 formed in the dielectric layer 102. The plurality of second metal interconnect features 106 are closely arranged to form a region 108 of relatively high feature density. Typically, the metal interconnect features 104, 106 are formed by depositing a metal fill material onto the dielectric layer 102 and into corresponding openings formed therein. The material surface of the substrate 100 is then planarized using a CMP process to remove the overburden of fill material from the field surface 110 of the dielectric layer 102. If the polishing pad selected for the CMP process, for example, a polishing pad formed with currently available liquid porogen-features, provides relatively poor local planarization performance due to lack of pad integrity, the resulting upper surface of the metal interconnect feature 104 may be recessed a distance “d” from the surrounding surfaces of the dielectric layer 102, otherwise known as dishing. Poor local planarization performance may also result in undesirable recessing of the dielectric layer 102 in the high feature density region 108, for example, distance “e”, where the upper surfaces of the dielectric layer 102 in the region 108 are recessed from the plane of the field surface 110, otherwise known as erosion. Metal loss resulting from dishing and/or erosion can cause undesirable variation in the effective resistance of the metal interconnect features 104, 106 formed therefrom thus affecting device performance and reliability.

### Exemplary Polishing System

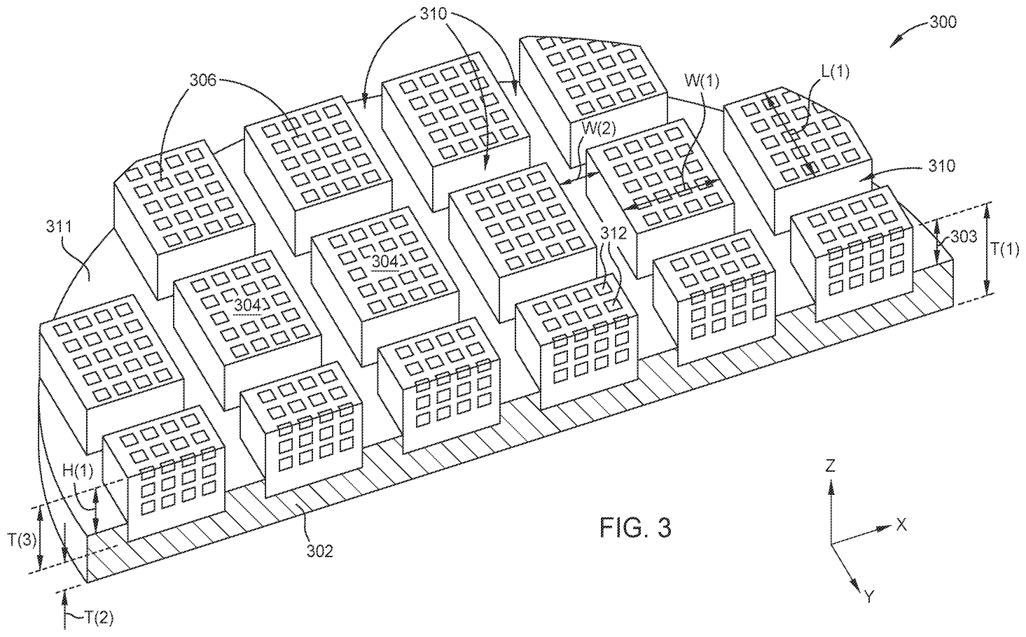

FIG. 2 is a schematic side view of an exemplary polishing system 200 configured to use a polishing pad 300 containing improved porogen-features formed according to implementations described herein. The polishing pad 300 is further described in FIG. 3.

Referring to FIG. 2, the polishing system 200 features a platen 204, having the polishing pad 300 secured thereto using a pressure sensitive adhesive, and a substrate carrier 206. The substrate carrier 206 faces the platen 204 and the polishing pad 300 mounted thereon. The substrate carrier 206 is used to urge a material surface of a substrate 208, disposed therein, against the polishing surface of the polishing pad 300 while simultaneously rotating about a carrier axis 210. Typically, the platen 204 rotates about a platen axis 212 while the rotating substrate carrier 206 sweeps back and forth from an inner diameter to an outer diameter of the platen 204 to in part, reduce uneven wear of the polishing pad 300.

The polishing system 200 further includes a fluid delivery arm 214 and a pad conditioner assembly 216. The fluid delivery arm 214 is positioned over the polishing pad 300 and is used to deliver a polishing fluid, such as a polishing slurry having abrasives suspended therein, to a surface of the polishing pad 300. Typically, the polishing fluid contains a pH adjuster and other chemically active components, such as an oxidizing agent, to enable chemical mechanical polishing of the material surface of the substrate 208. The pad conditioner assembly 216 is used to condition the polishing pad 300 by urging a fixed abrasive conditioning disk 218 against the surface of the polishing pad 300 before, after, or during polishing of the substrate 208. Urging the conditioning disk 218 against the polishing pad 300 includes rotating the conditioning disk 218 about a conditioner axis 220 and sweeping the conditioning disk 218 from an inner diameter the platen 204 to an outer diameter of the platen 204. The conditioning disk 218 is used to abrade and rejuvenate the polishing pad 300 polishing surface, and to remove polish byproducts or other debris from the polishing surface of the polishing pad 300. In addition, the mechanical abrasion provided by the conditioning disk 218 may be used to remove exposed improved porogen-features to achieve a targeted porosity at the surface of the polishing pad 300. The conditioning disk 218 may be used either alone or in combination with a water-based fluid to remove the exposed improved porogen-features.

### Polishing Pad Examples

The polishing pads described include a foundation layer and a polishing layer disposed on the foundation layer. The foundation layer, the polishing layer, or both the foundation layer and the polishing layer incorporate the improved porogen-features described herein. The polishing layer forms the polishing surface of the polishing pad and the foundation layer provides support for the polishing layer as a to-be-polished substrate is urged against the polishing surface. The foundation layer and the polishing layer can be formed of different pre-polymer compositions and the porogen-forming compositions described herein that, when cured, have different material properties. The foundation layer and the polishing layer are integrally and sequentially formed using a continuous layer-by-layer additive manufacturing process. The additive manufacturing process provides a polishing pad body having a continuous polymer phase between the polishing layer and the foundation layer thus eliminating the need for an adhesive layer or other bonding method therebetween. In at least one implementation, the polishing layer is formed of a plurality of polishing elements, which are separated from one another across the polishing surface by recesses, and/or channels, disposed therebetween.

The term “pore-feature,” as used herein includes openings defined in the polishing surface and voids that are formed in the polishing material below the polishing surface. The term porogen-feature as used herein includes porogen-features disposed in the polishing surface, porogen-features disposed in polishing material below the polishing surface, and combinations thereof. Porogen-features are removable from the polishing pad to form pore-features. Porogen-features typically include water-soluble-sacrificial materials or porogens as described that dissolve upon exposure to a polishing fluid, other water-based fluid, or mechanical abrasion, thus forming a corresponding opening in the polishing surface and/or void in the polishing material below the polishing surface. In some implementations, the water-soluble-sacrificial material may swell upon exposure to a polishing fluid thus deforming the surrounding polishing material to provide asperities at the polishing pad material surface. The resulting pore-features facilitate transporting liquid and abrasives to the interface between the polishing pad and a to-be-polished material surface of a substrate, and temporarily fixes those abrasives (abrasive capture) in relation to the substrate surface to enable chemical and mechanical material removal therefrom.

In at least one implementation, the polishing material of the polishing pad may be formed from different pre-polymer compositions and porogen-forming compositions, or different ratios of the different pre-polymer compositions and porogen-forming compositions, to provide unique material properties. For example, the polishing material may be formed from a first pre-polymer composition that forms the structural portions of the polishing pad and a porogen-forming composition that forms the porogen-features of the polishing pad.

Generally, the methods set forth herein use an additive manufacturing system, for example, a 2D or a 3D inkjet printer system, to form (print) at least portions of the polishing pads in a layer-by-layer process. Typically, each print layer is formed (printed) by sequentially depositing and at least partially curing droplets of targeted pre-polymer compositions and/or porogen-forming compositions as described herein on a manufacturing support or a previously formed print layer. Beneficially, the additive manufacturing system and the methods set forth herein enable at least micron scale droplet placement control within each print layer (X-Y resolution) as well as micron scale (0.1 μm to 200 μm) control over the thickness (Z resolution) of each print layer. The micron scale X-Y and Z resolutions provided by the additive manufacturing systems and the methods set forth herein facilitate the formation of desirable and repeatable patterns of the porogen-features described herein. Thus, in at least one implementation, the additive manufacturing methods used to from the polishing pads also impart one or more distinctive structural characteristics of the polishing pads formed therefrom.

FIG. 3 is a schematic isometric sectional view of a polishing pad 300, which may be formed using the methods set forth herein. Here, the polishing pad 300 includes a foundation layer 302 and a polishing layer 303 disposed on the foundation layer 302 and integrally formed therewith using an additive manufacturing process. The additive manufacturing process allows for co-polymerization of different pre-polymer compositions used to respectively form the foundation layer 302 and the polishing layer 303, thus providing a continuous phase of polymer material across the interfacial boundary regions therebetween with porogen-features interspersed therein.

Here, the polishing layer 303 is formed of a plurality of polishing elements 304 that extend upwardly from the foundation layer 302 to form a polishing surface 306. In the illustrated implementations, the plurality of polishing elements 304 are spaced apart from one another to define a plurality of channels 310 therebetween. The plurality of channels 310 are disposed between adjacent ones of the plurality of polishing elements 304 and between a plane of the polishing surface 306 and an upward facing surface 311 of the foundation layer 302. The plurality of channels 310 facilitate the distribution of polishing fluids across the polishing pad 300 and to an interface between the polishing surface 306 and a material surface of a substrate to be polished thereon. The plurality of polishing elements 304 are supported in a thickness direction (Z-direction) of the polishing pad 300 by a portion of the foundation layer 302. Thus, when a load is applied to the polishing surface 306 by a substrate urged against the polishing surface 306, the load will be transmitted through the polishing elements 304 and to the portion of the foundation layer 302 disposed beneath the polishing elements 304.

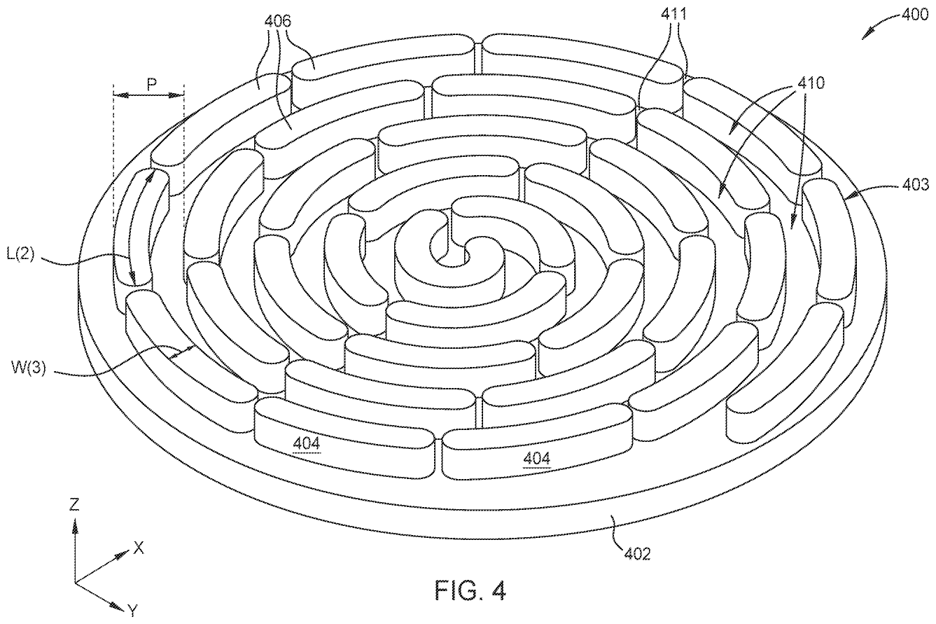

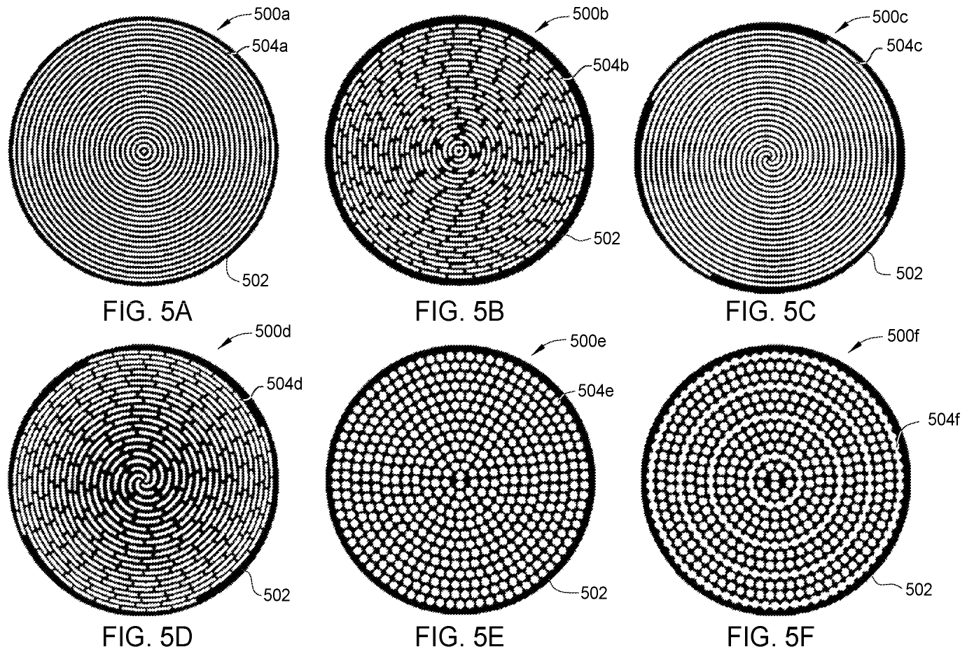

Here, the plurality of polishing elements 304 are formed to have a substantially rectangular shape (square as shown) when viewed from top down and are arranged so that the plurality of channels 310 defined therebetween form an X-Y grid pattern. Alternate shapes and/or arrangements of polishing elements that may be used for the polishing elements 304, and the channels 310 defined therefrom, are illustrated in FIG. 4 and FIGS. 5A-5F. In at least one implementation, the shapes, dimensions, and/or arrangements of the polishing elements 304, and/or the channels 310 disposed between the polishing elements 304, are varied across the polishing pad 300 to tune hardness, mechanical strength, fluid transport characteristics, and/or other desirable properties thereof. In at least one implementation, the polishing layer 303 may not include discrete polishing elements and/or channels 310 defined between polishing surfaces of adjacent polishing elements may not extend through to the foundation layer 302.

Here, the polishing pad 300 has a first thickness T(1) measured between a platen mounting surface and the polishing surface 306 of between about 5 mm and about 30 mm. The foundation layer 302 has a second thickness T(2) of between about ⅓ to about ⅔ of the first thickness T(1). The polishing elements 304 have a third thickness T(3) that is between about ⅓ and about ⅔ of the first thickness T(1). As shown, at least a portion of the polishing elements 304 extend through an X-Y plane of the upward facing surface 311 of the foundation layer 302 to a location inside the foundation layer 302. The remaining portion of the polishing elements 304 extend upwardly or outwardly of the foundation layer 302 by a height H(1) from the X-Y plane of the upward facing surface 311 of the foundation layer 302. The height H(1) of the polishing elements 304 defines a depth of the channels 310 interposed between the polishing elements 304. In at least one implementation, the height H(1) of the polishing elements 304, and thus the depth of the channels 310, is about ½ of the first thickness T(1) or less. In at least one implementation, a height H(1) of the polishing elements 304, and thus the depth of the channels 310, is about 15 mm or less, such as about 10 mm or less, about 5 mm or less, or between about 100 μm and about 5 mm, such as about 800 μm.

Here, at least one lateral dimension of the polishing elements 304, for example, one or both of W(1) and L(1) when viewed from above, is in a range from about 5 mm to about 30 mm, or in a range from about 5 mm to about 20 mm, or in a range from about 5 mm to about 15 mm. The upper surfaces of the polishing elements 304 are parallel to the X-Y plane and form a polishing surface 306, which together form the total polishing surface of the polishing pad 300. Sidewalls of the polishing elements 304 are substantially vertical (orthogonal to the X-Y plane), such as within about 20° of vertical, or within 10° of vertical. Individual ones of the plurality of polishing elements 304 are spaced apart from one another in the X-Y plane by a width W(2) of the individual channels 310 defined between the polishing elements 304. Here, the width W(2) of the individual channels 310 is more than about 100 μm and less than about 5 mm, such as less than about 4 mm, less than about 3 mm, less than about 2 mm, or less than about 1 mm. In at least one implementation, one or both of the lateral dimensions W(1) and L(1) of the polishing elements 304 and/or the width W(2) of the individual channels 310 vary across a radius of the polishing pad 300 to allow fine tuning of the polishing performance thereof.

The polishing elements 304 include a plurality of porogen-features 312 disposed therein. The porogen-features 312 are removable to form pore-features as described herein. The plurality of porogen-features 312 may be disposed in any targeted vertical arrangement when viewed in cross-section. For example, in FIG. 3, the plurality of porogen-features 312 are vertically disposed in columnar arrangements where the porogen-features 312 in each of the columns are in substantial vertical alignment. In some other examples, groups of rows or individual rows of porogen-features 312 in the depth direction of the polishing elements 304 may be offset in one or both of X-Y directions to provide corresponding porogen-features 312 below the polishing surface 306 that are vertically staggered with respect to the porogen-features 312 disposed there above and/or there below. The orientation of the porogen-features 312 can be advantageously used to adjust the compliance of the polishing material with respect to a direction of the load exerted by a substrate that is being polished thereon. Thus, in one example, the staggered porogen-features 312 may be advantageously used to adjust and/or control the polishing planarization performance of a polishing pad formed therefrom.

In at least one implementation, the individual porogen-features 312 may have a height of about 600 μm or less, such as about 500 μm or less, about 400 μm or less, about 300 μm or less, about 200 μm or less, about 100 μm or less, about 50 μm or less, about 40 μm or less, about 30 μm or less, about 20 μm or less, or about 10 μm or less. The height of individual porogen-features 312 is typically a multiple, for example, 1× or more, of a thickness of the each of the print layers. For example, the thickness of the porogen-features 312 within a print layer may be the same as the thickness of the continuous polymer phase of polishing material disposed adjacent thereto. Thus, if porogen-features laterally disposed within at least two sequentially deposited print layers are aligned or at least partially overlap in the Z-direction, the thickness of the resulting porogen-feature is at least the combined thickness of the at least two sequentially deposited print layers. In at least one implementation, one or more of the porogen-features do not overlap with a porogen-feature in an adjacent layer disposed there above or there below and thus has a thickness of a single print layer.

In at least one implementation, the individual porogen-features 312 are formed to have lateral dimensions, for example, length/width or diameter, measured in an X-Y plane of about 600 μm or less, such as about 500 μm or less, about 400 μm or less, about 300 μm or less, about 200 μm or less, about 100 μm or less, about 50 μm or less, about 40 μm or less, about 30 μm or less, about 20 μm or less, or about 10 μm or less and about 5 μm or more, such as about 10 μm or more, about 25 μm or more, or about 50 μm or more. In at least one implementation, the mean lateral dimensions of the individual porogen-features 312 are in a range from about 50 μm to about 600 μm. In at least one implementation, the porogen-features 312 are formed to be relatively narrow in the X-Y plane compared to the height thereof, for example, in some implementations, lateral dimensions of the individual porogen-features 312 are about ⅔ or less than the height thereof, such as about ½ or less, or about ⅓ or less.

Here, individual ones of the plurality of porogen-features 312 are spaced apart in the vertical direction by one or more printed layers of polymer material formed between the plurality of porogen-features 312. In some examples, spacing between porogen-features 312 in a vertical direction may be about 100 μm or less, such as about 40 μm or less, such as about 10 μm or less, or about 10 μm to about 40 μm. The pore-features may form a substantially closed-celled structure once the sacrificial-material used to form the porogen-features 312 is removed therefrom. In one example, spacing between porogen-features 312 in the vertical direction may be about 40 μm. The 40 μm spacing can be formed by disposing four 10 μm print layers of the polymer material between the printed layers that include the porogen-features 312. In another example, spacing between porogen-features 312 in the vertical direction may be about 10 μm. The 10 μm spacing can be formed by disposing four 2.5 μm print layers of the polymer material between the printed layers that include the porogen-features 312.

In other implementations, one or more of the porogen-features 312, or portions thereof, are not spaced apart from one or more of the porogen-features 312 adjacent thereto and thus form a more open-celled structure once the porogen-features 312 are removed therefrom. A thickness of the one or more printed layers may be about 5 μm or more, such as about 10 μm or more, 20 μm or more, 30 μm or more, 40 μm or more, or 50 μm or more. The individual porogen-features 312 may be formed within a corresponding single print layer and thus have a height corresponding to the thickness of the print layer or may be formed within two or more adjacent print layers to provide a pore height corresponding to the cumulative thickness thereof.

In at least one implementation, the polishing elements 304 are formed of a continuous polymer phase of polymer material. The polymer material may have a relatively low storage modulus (E′), for example, a soft pad material, a relatively high storage modulus E′, for example, a hard pad material, or a relatively medium storage modulus E′ between the relatively low and relatively high storage modulus, i.e., a medium pad material. In some examples, the polymer material may have a generally homogenous material composition. In some other examples, the polymer material may include at least two pre-polymer compositions, and thus include a combination of low, medium, or high storage modulus E′ materials with a difference from one another in one or more material properties. Characterizations of the low, medium, and high storage modulus E′ materials at a temperature of about 30° C. (E′30) include an E′30 less than or equal to 100 MPa (e.g., in a range form about 1 MPa to about 100 MPa) for low storage modulus compositions, an E′30 in a range from about 100 MPa to about 500 MPa for medium storage modulus, and an E′30 greater than or equal to 500 MPa (e.g., in a range from about 500 MPa to about 3,000 MPa.

FIG. 4 schematically illustrates a polishing pad 400 featuring alternate shapes for the polishing elements 404 formed thereon, according to some implementations. FIG. 4 is a schematic isometric view of the polishing pad 400. Features of the polishing pad 400 may be incorporated into or combined with any of the features of the polishing pad 300 described above. The polishing pad 400 includes the porogen-features as described herein.

Here, the polishing pad 400 includes a foundation layer 402 and a polishing layer 403 disposed on the foundation layer 402 and integrally formed therewith to provide a continuous phase of polymer material across the interfacial boundary regions therebetween. The polishing layer 403 is formed of a plurality of discrete polishing elements 404 disposed on or partially within the foundation layer 402. The plurality of polishing elements 404 extend upwardly from an upward facing surface 411 of the foundation layer 402 to form a polishing surface 406. The plurality of polishing elements 404 are spaced apart from one another to define a plurality of channels 410 therebetween. Here, the plurality of polishing elements 404 are arranged to form corresponding segments of a spiral pattern. The spiral pattern extends from an inner radius of the polishing pad 400 to an outer radius proximate to the circumference of the polishing pad 400. Here, individual ones of the plurality of polishing elements have an arc length L(2) of between about 2 mm and about 200 mm and a width W(3) of between about 200 μm and about 10 mm, such as between about 1 mm and about 5 mm. A pitch P between the maximum radius sidewalls of radially adjacent polishing elements 404 may be between about 0.5 mm and about 20 mm, such as between about 0.5 mm and about 10 mm. In at least one implementation, one or both of the arc length L(2), the width W(3), and the pitch P vary across a radius of the polishing pad 400 to define regions of different localized polishing performance.

FIGS. 5A-5F are schematic plan views of polishing pads 500a-f having various shapes and/or arrangements of polishing elements 504a-f that may be used in combination with or in place of any of the other polishing element shapes and/or arrangements described herein. The polishing pads 500a-f include the porogen-features as described herein. Each of the FIGS. 5A-5F includes a pixel chart having white regions (regions in white pixels) that represent the polishing elements 504a-f and black regions (regions in black pixels) that represent the foundation layer 502, as viewed from above.

In FIG. 5A, the polishing elements 504a include a plurality of concentric annular rings. In FIG. 5B, the polishing elements 504b include a plurality of segments of concentric annular rings. In FIG. 5C, the polishing elements 504c form a plurality of spirals (four shown) extending from a center of the polishing pad 500c to an edge of the polishing pad 500c or proximate thereto. In FIG. 5D, a plurality of discontinuous polishing elements 504d are arranged in a spiral pattern on the foundation layer 502.

In FIG. 5E, each of the plurality of polishing elements 504e includes a cylindrical post extending upwardly from the foundation layer 502. In other implementations, the polishing elements 504e are of any suitable cross-sectional shape, for example columns with toroidal, partial toroidal, for example, arc, oval, square, rectangular, triangular, polygonal, irregular shapes in a section cut generally parallel to the underside surface of the pad 500e, or combinations thereof. FIG. 5F illustrates a polishing pad 500f having a plurality of discrete polishing elements 504f extending upwardly from the foundation layer 502. The polishing pad 500f of FIG. 5F is similar to the polishing pad 500e except that some of the polishing elements 504f are connected to form one or more closed circles. The one or more closed circles create damns to retain polishing fluid during a CMP process.

### Additive Manufacturing System

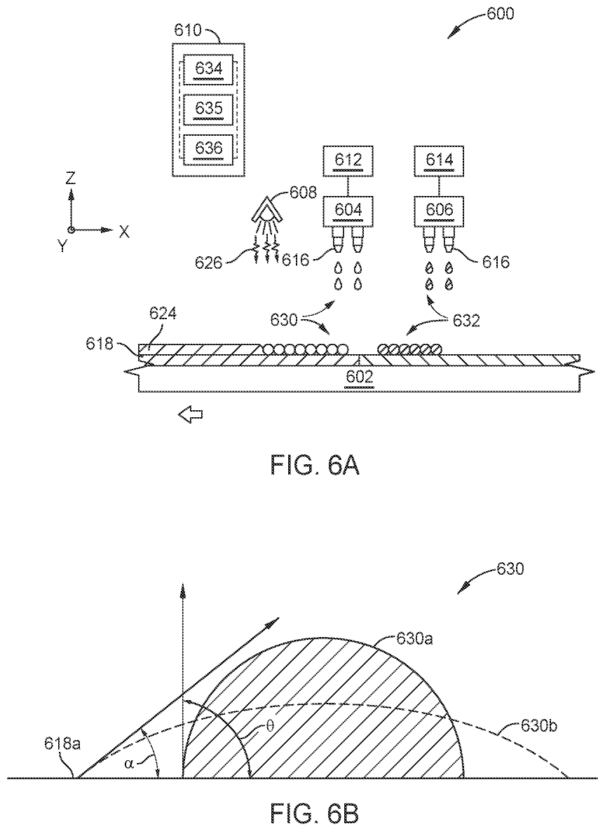

FIG. 6A is a schematic sectional view of an additive manufacturing system, which may be used to form the polishing pads described herein, according to some implementations. Here, the additive manufacturing system 600 features a movable manufacturing support 602, a plurality of dispense heads 604 and 606 disposed above the manufacturing support 602, a curing source 608, and a system controller 610. In at least one implementation, the dispense heads 604, 606 move independently of one another and independently of the manufacturing support 602 during the polishing pad manufacturing process. Here, the first and second dispense heads 604 and 606 are respectively fluidly coupled to a first pre-polymer composition 612 and a porogen-forming composition 614. In at least one implementation, the first dispense head is adapted to deposit a pre-polymer composition that forms the structural regions of the polishing pad and the second dispense head 606 is adapted to deposit a porogen-forming composition that forms the porogen-features. Typically, the additive manufacturing system 600 features at least one more dispense head, for example, a third dispense head (not shown), which is fluidly coupled to a second pre-polymer composition source used to form a foundation layer. In at least one implementation, the additive manufacturing system 600 includes as many dispense heads as targeted to each dispense a different pre-polymer composition or porogen-forming composition. In at least one implementation, the additive manufacturing system 600 further includes pluralities of dispense heads where two or more dispense heads are configured to dispense the same pre-polymer compositions or porogen-forming compositions.

Here, each of dispense heads 604, 606 features an array of droplet ejecting nozzles 616 configured to eject droplets 630, 632 of the respective pre-polymer composition 612 and porogen-forming composition 614 delivered to the dispense head reservoirs. Here, the droplets 630, 632 are ejected towards the manufacturing support 602 and thus onto the manufacturing support 602 or onto a previously formed print layer 618 disposed on the manufacturing support 602. Typically, each of dispense heads 604, 606 is configured to fire (control the ejection of) droplets 630, 632 from each of the nozzles 616 in a respective geometric array or pattern independently of the firing of other nozzles 616 thereof. Herein, the nozzles 616 are independently fired according to a droplet dispense pattern for a print layer to be formed, such as the print layer 624, as the dispense heads 604, 606 move relative to the manufacturing support 602. Once dispensed, the droplets 630 of the pre-polymer composition 612 and/or the droplets 632 of the porogen-forming composition 614 are at least partially cured by exposure to electromagnetic radiation by the curing source 608. For example, UV radiation 626, near UV, visible light, infrared or far infrared radiation, provided by the curing source 608, to form a print layer, such as the partially formed print layer 624.

Here, the additive manufacturing system 600 shown in FIG. 6A further includes the system controller 610 to direct the operation thereof. The system controller 610 includes a programmable central processing unit (CPU) 634, which is operable with a memory 635, for example, a non-volatile memory, and support circuits 636. The support circuits 636 are conventionally coupled to the CPU 634 and include cache, clock circuits, input/output subsystems, power supplies, and the like, and combinations thereof coupled to the various components of the additive manufacturing system 600, to facilitate control thereof. The CPU 634 is one of any form of general-purpose computer processor used in an industrial setting, such as a programmable logic controller (PLC), for controlling various components and sub-processors of the additive manufacturing system 600. The memory 635, coupled to the CPU 634, is non-transitory and is typically one or more of readily available memories such as random access memory (RAM), read only memory (ROM), floppy disk drive, hard disk, or any other form of digital storage, local or remote.

Typically, the memory 635 is in the form of a computer-readable storage medium containing instructions, for example, non-volatile memory, which when executed by the CPU 634, facilitates the operation of the additive manufacturing system 600. The instructions in the memory 635 are in the form of a program product such as a program that implements the methods of the present disclosure, for example, the method 700.

The program code may conform to any one of a number of different programming languages. In one example, the disclosure may be implemented as a program product stored on computer-readable storage media for use with a computer system. The program(s) of the program product define functions of the implementations (including the methods described herein).

Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are implementations of the present disclosure. In at least one implementation, the methods set forth herein, or portions thereof are performed by one or more application specific integrated circuits (ASICs), field-programmable gate arrays (FPGAs), or other types of hardware implementations. In some other implementations, the polishing pad manufacturing methods set forth herein are performed by a combination of software routines, ASIC(s), FPGAs and, or, other types of hardware implementations.

Here, the system controller 610 directs the motion of the manufacturing support 602, the motion of the dispense heads 604 and 606, the firing of the nozzles 616 to eject droplets of pre-polymer composition and porogen-forming compositions therefrom, and the degree and timing of the curing of the dispensed droplets provided by the UV radiation source 608. In at least one implementation, the instructions used by the system controller 610 to direct the operation of the additive manufacturing system 600 include droplet dispense patterns for each of the print layers to be formed. In some implementations, the droplet dispense patterns are collectively stored in the memory 635 as CAD-compatible digital printing instructions.

In at least one implementation, dispensed droplets of the pre-polymer composition and/or the porogen-forming composition, such as the dispensed droplets 630 of the pre-polymer composition 612, are exposed to electromagnetic radiation to physically fix the droplet before it spreads to an equilibrium size such as set forth in the description of FIG. 6B. Typically, the dispensed droplets are exposed to electromagnetic radiation to at least partially cure the pre-polymer compositions thereof within one second or less of the droplet contacting a surface, such as the surface of the manufacturing support 602 or of a previously formed print layer 618 disposed on the manufacturing support 602.

FIG. 6B is a close up cross-sectional view schematically illustrating a droplet 630 disposed on a surface 618a of a previously formed layer, such as the previously formed print layer 618 described in FIG. 6A, according to some implementations. In a typical additive manufacturing process, a droplet of pre-polymer composition, such as the droplet 630, spreads and reaches an equilibrium contact angle α with the surface 618a of the previously formed layer within about one second from the moment in time that the droplet 630 contacts the surface 618a. The equilibrium contact angle α is a function of at least the material properties of the pre-polymer composition and the energy at the surface 618a (surface energy) of the previously formed layer. In at least one implementation, it is desirable to at least partially cure the dispensed droplet before it reaches an equilibrium size in order to fix the droplet's contact angle with the surface 618a of the previously formed layer. In those implementations, the fixed droplet's 630a contact angle θ is greater than the equilibrium contact angle α of the droplet 630b (shown in phantom) of the same pre-polymer composition, which was allowed to spread to its equilibrium size.

Herein, at least partially curing a dispensed droplet causes at least partial polymerization, for example, cross-linking, of the pre-polymer composition(s) within the droplets and with adjacently disposed droplets of the same or different pre-polymer compositions to form a continuous polymer phase. In some implementations, the pre-polymer compositions are dispensed and at least partially cured to form a well about a targeted pore before a porogen-forming composition is dispensed within the well.

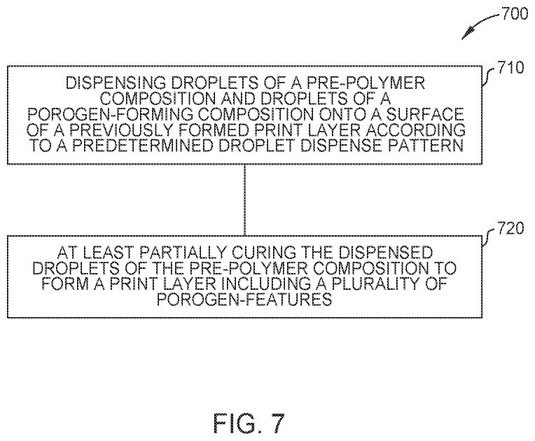

FIG. 7 is a flow chart setting forth a method of forming a polishing pad in accordance with one or more implementations of the present disclosure. Implementations of the method 700 may be used in combination with one or more of the systems and system operations described herein, such as the additive manufacturing system 600 of FIG. 6A and the fixed droplets of FIG. 6B. Further, embodiments of the method 700 may be used to form any one or combination of implementations of the polishing pads shown and described herein.

At operation 710, the method 700 includes dispensing droplets of a pre-polymer composition and droplets of a porogen-forming composition as described onto a surface of a previously formed print layer according to a predetermined droplet dispense pattern.

At operation 720, the method 700 includes at least partially curing the dispensed droplets of the pre-polymer composition and/or the porogen-forming composition to form a print layer including a plurality of porogen-features.

The pre-polymer composition of the present disclosure may include a mixture of one or more of functional polymers, functional oligomers, functional monomers, functional cross-linkers, reactive diluents, additives, and photoinitiators.

Examples of suitable functional polymers which may be used to form one or both of the pre-polymer composition and the porogen-forming composition include multifunctional acrylates including di, tri, tetra, and higher functionality acrylates, such as 1,3,5-triacryloylhexahydro-1,3,5-triazine or trimethylolpropane triacrylate, dipropylene glycol diacrylate or dimethacrylate.

Examples of suitable functional oligomers which may be used to form one or both of the pre-polymer composition and the porogen-forming composition include monofunctional and multifunctional oligomers, acrylate oligomers, such as aliphatic urethane acrylate oligomers, aliphatic hexafunctional urethane acrylate oligomers, diacrylate, aliphatic hexafunctional acrylate oligomers, multifunctional urethane acrylate oligomers, aliphatic urethane diacrylate oligomers, aliphatic urethane acrylate oligomers, aliphatic polyester urethane diacrylate blends with aliphatic diacrylate oligomers, or combinations thereof, for example bisphenol-A ethoxylate diacrylate or polybutadiene diacrylate, tetrafunctional acrylated polyester oligomers, aliphatic polyester based urethane diacrylate oligomers and aliphatic polyester based acrylates and diacrylates.

Examples of suitable monomers which may be used to from one or both of the pre-polymer composition and the porogen-forming composition include both mono-functional monomers and multifunctional monomers. Suitable mono-functional monomers include tetrahydrofurfuryl acrylate (e.g. SR285 from Sartomer®), tetrahydrofurfuryl methacrylate, vinyl caprolactam, isobornyl acrylate, isobornyl methacrylate, 2-phenoxyethyl 2-phenoxyethyl methacrylate, 2-(2-ethoxyethoxy)ethyl acrylate, isooctyl acrylate, isodecyl acrylate, isodecyl methacrylate, lauryl acrylate, lauryl methacrylate, stearyl acrylate, stearyl methacrylate, cyclic trimethylolpropane formal acrylate, 2-[[(Butylamino) carbonyl]oxy]ethyl acrylate (e.g. Genomer 1122 from RAHN USA Corporation), cycloaliphatic acrylate (e.g. SR217 from Sartomer®), 3,3,5-trimethylcyclohexyl acrylate, or mono-functional methoxylated PEG (350) acrylate. Suitable multifunctional monomers include diacrylates or dimethacrylates of diols and polyether diols, such as propoxylated neopentyl glycol diacrylate, 1,6-hexanediol diacrylate, 1,6-hexanediol dimethacrylate, 1,3-butylene glycol diacrylate, 1,3-butylene glycol dimethacrylate 1,4-butanediol diacrylate, 1,4-butanediol dimethacrylate, alkoxylated aliphatic diacrylate (e.g., SR9209A from Sartomer®), diethylene glycol diacrylate, diethylene glycol dimethacrylate, dipropylene glycol diacrylate, tripropylene glycol diacrylate, triethylene glycol dimethacrylate, alkoxylated hexanediol diacrylates, or combinations thereof, for example SR508, SR562, SR563, SR564 from Sartomer®.

In one or more implementatinos, which can be combined with other implementations, the reactive diluents used to form one or more of the pre-polymer composition and the porogen-forming composition are at least monofunctional, and undergo polymerization when exposed to free radicals, Lewis acids, and/or electromagnetic radiation. Examples of suitable reactive diluents include monoacrylate, 2-ethylhexyl acrylate, octyldecyl acrylate, cyclic trimethylolpropane formal acrylate, caprolactone acrylate, isobornyl acrylate (IBOA), or alkoxylated lauryl methacrylate. In some examples, reactive diluents may include Genocure series products, such as PBZ, or Genomer series products, such as Genomer 5142, each manufactured by Rahn A G of Zurich, Switzerland.

Examples of suitable additives include surface modifiers such as surfactants to control surface tension. Some example additives may include ethoxylated polydimethylsiloxanes, such as BYK series products, such as BYK-307, manufactured by BYK-Chemie GmbH of Wesel, Germany.

In some implementations, the method 700 further includes sequential repetitions of operations 710 and 720 to form a plurality of print layers stacked in a Z-direction, for example, a direction orthogonal to the surface of the manufacturing support or a previously formed print layer disposed thereon. The predetermined droplet dispense pattern used to form each print layer may be the same or different as a predetermined droplet dispense pattern used to form a previous print layer disposed there below. In some embodiments, the plurality of print layers include a polishing layer having a plurality of porogen-features formed therein. In some implementations, the plurality of print layers include a polishing layer having a plurality of porogen-features formed therein in which the plurality of porogen-features are formed from the porogen-forming composition.

### EXAMPLES

### Formulation and Material Examples

The polishing pads described herein may be formed from at least a pre-polymer composition or photocurable printing composition, which forms the structural regions of the polishing pad, and a porogen-forming composition or photocurable porogen-forming printing composition, which forms the removable porogen-features of the polishing pad. The photocurable printing composition and the porogen-forming composition are jettable. The porogen-forming composition, which contains at least photopolymerizable compounds and a photopolymerization initiator, is explained in further detail. There may be compounds that fall under two or more categories of the compounds listed below. Such compounds are treated as belonging to each of the two or more categories and counted multiple times toward the contents of the respective categories.

The photocurable porogen-forming composition may comprise, consist essentially of, or consist of one or more of: (1) one or more functional acrylate oligomer components; (2) an acrylate monomer mixture including one or more of (2A) one or more (meth)acrylate monomer compounds having at least one (meth)acryloyloxy group, (2B) one or more ethoxylated acrylate monomer compounds, (2C) one or more acrylamide monomer compounds; and (2D) one or more nitrogen-containing monofunctional vinyl monomers; (3) one or more dissolute compounds including (3A) a polyhydroxy compound having two or more hydroxyl groups, and (3B) a cyclic carbonate ester; (4) one or more photoinitiator components; and/or (5) additional additives.

In one or more implementations, which can be combined with other implementations, the porogen-forming composition includes one or more functional acrylate oligomer components (1).

In one or more implementations, which can be combined with other implementations, the one or more functional acrylate oligomer components (1) includes one or more adhesion promoters containing one or more acrylate groups. The adhesion promoter can be an acidic modified adhesion promotor or an amine modified adhesion promotor.

Examples of acidic modified adhesion promotors include acidic acrylate oligomers, acrylic acid, polyester acrylate oligomers, β-carboxyethyl acrylate, and acid functional acrylic resins.

In one or more implementations, the acidic modified adhesion promoter is an acidic acrylate oligomer having a functionality of one, a viscosity at 25° C. of 115 cPs, and a T(g° C.), by DSC, of 18. One example, of a suitable acidic acrylate oligomer is CN147 acidic acrylate oligomer, which is available from Sartomer.

If present, the acidic modified adhesion promoter generally is present in an amount in a range from about 1 wt. % to about 30 wt. %, or in a range from about 5 wt. % to about 20 wt. %, or in a range from about 10 wt. % to about 20 wt. %, or in a range from about 15 wt. % to about 20 wt. % based on a total weight of the porogen-forming composition.

In one or more implementations, which can be combined with other implementations, the one or more functional acrylate oligomer components (1) includes a water-soluble oligomer containing one or more acrylate groups.

Examples of the water-soluble oligomer include a water-soluble aliphatic alkyl epoxy difunctional acrylate oligomer.

In one or more implementations, the water-soluble aliphatic alkyl epoxy difunctional acrylate oligomer has a viscosity at 25° C. of 1500 cPs, and a molecular weight of 750. One example, of suitable water-soluble oligomer is MIRAMER PE220 water-soluble aliphatic alkyl epoxy difunctional acrylate oligomer, which is available from Miwon Specialty Chemical Co. Ltd.

There are several benefits of using water-soluble oligomers in the porogen-forming composition including easy removal of the formed porogen regions by water due to the presence of the water-soluble oligomers.

If present, the water-soluble oligomer generally is present in an amount in a range from about 1 wt. % to about 30 wt. %, or in a range from about 5 wt. % to about 20 wt. %, or in a range from about 10 wt. % to about 20 wt. %, or in a range from about 15 wt. % to about 20 wt. % based on a total weight of the porogen-forming composition.

In one or more implementations, which can be combined with other implementations, the porogen-forming composition further includes an acrylate monomer mixture (2). The acrylate monomer mixture (2) can include one or more of (2A) one or more (meth)acrylate monomer compounds having at least one (meth)acryloyloxy group, (2B) one or more ethoxylated acrylate monomer compounds, (2C) one or more acrylamide monomer compounds; and (2D) one or more nitrogen-containing monofunctional vinyl monomers.

In one or more implementations, which can be combined with other implementations, the porogen-forming composition further includes a (meth)acrylate compound having at least one (meth)acryloyloxy group as component (2A). The (meth)acrylate compound (2A) can be a fully or partially water-soluble (meth)acrylate compound.

In one or more implementations, which can be combined with other implementations, the (meth)acrylate compound (2A) includes monofunctional (meth)acrylate compounds having one (meth)acryloyloxy group and polyfunctional (meth)acrylate compounds having two or more (meth)acryloyloxy groups, and the porogen-forming composition used for forming the porogen regions may include only monofunctional (meth)acrylate compounds or only polyfunctional (meth)acrylate compounds as the (meth)acrylate compound (2A), or it may include both monofunctional (meth)acrylate and polyfunctional (meth)acrylate compounds.

Examples of the monofunctional (meth)acrylate compounds include hydroxyethyl (meth)acrylate, hydroxypropyl (meth)acrylate and other such mono(meth)acrylates of aliphatic diols, polyethylene glycol mono(meth)acrylate, polypropylene glycol mono(meth)acrylate, polytetramethylene glycol mono(meth)acrylate, polyethylene glycol/polypropylene glycol copolymer mono(meth)acrylate and other such mono(meth)acrylates of aliphatic polyalkylene glycols, and mono(meth)acrylates of polyester diols, in particular aliphatic diols, and one, two or more of these can be used.

Examples of the polyfunctional (meth)acrylate compounds include polyfunctional (meth)acrylate compounds having an aliphatic polyether structure or an aliphatic polyester structure such as di(meth)acrylates of aliphatic polyalkylene glycols such as polyethylene glycol di(meth)acrylate, polypropylene glycol di(meth)acrylate, polytetramethylene glycol di(meth)acrylate and polyethylene glycol/polypropylene glycol copolymer di(meth)acrylate, the di(meth)acrylates of aliphatic polyester diols, and the di(meth)acrylates of urethanes with an aliphatic polyether structure or an aliphatic polyester structure, and one, two or more of these can be used.

In one or more implementations where the monofunctional (meth)acrylate or the polyfunctional (meth)acrylate has an aliphatic polyether structural region or an aliphatic polyester structural region in the molecule, the molecular weight of said aliphatic polyether structural region or aliphatic polyester structural region can be in a range from about 200 to about 2000, or in a range from about and preferably from about 400 to 1600, or in a range from about 400 to about 800, for example, about 400, about 600, or about 700.

In one or more implementations, the (meth)acrylate compound having at least one (meth)acryloyloxy group is selected from methoxy polyethylene glycol monoacrylates, polyethylene glycol diacrylates, or a combination thereof. The methoxy polyethylene glycol monoacrylate can be methoxy polyethylene glycol (350) monoacrylate having a functionality of one, a viscosity at 25° C. of 22 cPs, and a molecular weight of 404 g/mol. One suitable example is Sartomer SR551 methoxy polyethylene glycol (350) monoacrylate. The methoxy polyethylene glycol monoacrylate can be methoxy polyethylene glycol (550) monoacrylate having a functionality of one, a viscosity at 50° C. of 22 cPs, and a molecular weight of 604 g/mol. One suitable example is Sartomer SR553 methoxy polyethylene glycol (550) monoacrylate. The polyethylene glycol diacrylates can be polyethylene glycol (600) diacrylate having a functionality of two, a viscosity at 50° C. of 90 cPs, and a molecular weight of 708 g/mol. One suitable example is Sartomer SR610 polyethylene glycol (600) diacrylate.

There are several benefits of using water-soluble monomers in the porogen-forming composition including easy removal of the formed porogen regions by water due to the presence of the water-soluble monomers while still maintaining photocurability.

If present, the polyfunctional (meth)acrylate monomer compound generally is present in an amount in a range from about 1 wt. % to about 25 wt. %, or in a range from about 5 wt. % to about 20 wt. %, or in a range from about 5 wt. % to about 10 wt. % based on a total weight of the porogen-forming composition. If present, the monofunctional (meth)acrylate monomer compound generally is present in an amount in a range about 1 wt. % to about 25 wt. %, or in a range from about 5 wt. % to about 20 wt. %, or in a range from about 10 wt. % to about 20 wt. % based on a total weight of the porogen-forming composition.

When a monofunctional (meth)acrylate compound is used as the (meth)acrylate compound having at least one (meth)acryloyloxy group (2A), porogen-features with good water solubility are formed, and when a polyfunctional (meth)acrylate compound is used porogen-features of good support performance, which improve pad integrity are formed.

In one or more implementations, which can be combined with other implementations, the porogen-forming composition further includes (2B) one or more ethoxylated acrylate monomer compounds.

In one or more implementations, which can be combined with other implementations, the one or more ethoxylated acrylate monomer compounds (2B) include one or more ethoxylated multifunctional acrylate monomer compounds. The one or more ethoxylated acrylate monomer compounds (2B) can be an ethoxylated diacrylate monomer compound, an ethoxylated triacrylate monomer compound, or a combination thereof.

Examples of ethoxylated acrylate monomer compounds (2B) include an ethoxylated (15) trimethylolpropane triacrylate monomer, an ethoxylated (30) Bisphenol A Diacrylate monomer, or a combination thereof.

In one or more implementations, the ethoxylated acrylate monomer compounds (2B) is an ethoxylated (15) trimethylolpropane triacrylate monomer having a functionality of three, a viscosity at 25° C. of 168 cPs, a molecular weight of 945 g/mol, and a T(g° C.), by DSC, of −32. One example, of a suitable ethoxylated (15) trimethylolpropane triacrylate monomer is SR9035 ethoxylated (15) trimethylolpropane triacrylate monomer, which is available from Sartomer.

In one or more implementations, the ethoxylated acrylate monomer compound (2B) includes an ethoxylated (30) Bisphenol A diacrylate monomer having a functionality of two, a viscosity at 25° C. of 680 cPs, a molecular weight of 1658 g/mol, and a T(g° C.), by DSC, of −42. One example, of a suitable ethoxylated (30) Bisphenol A diacrylate monomer is SR9038 ethoxylated (30) Bisphenol A diacrylate monomer, which is available from Sartomer.

There are several benefits of using the one or more ethoxylated acrylate monomer compounds (2B) in the porogen-forming composition including cross-linking. Additionally, in one or more implementations where the molecular weight is high, for example, 900 g/mol or greater, the one or more ethoxylated acrylate monomer compounds (2B) can function as an oligomer which contributes to the cured integrity of the formed pad.

If present, the (meth)acrylate compound having the one or more ethoxylated acrylate monomer compounds generally is present in an amount in a range from about 1 wt. % to about 20 wt. %, or in a range from about 5 wt. % to about 20 wt. %, or in a range from about 10 wt. % to about 20 wt. %, or in a range from about 10 wt. % to about 15 wt. % based on a total weight of the porogen-forming composition.

In one or more implementations, which can be combined with other implementations, the porogen-forming composition further includes (2C) one or more acrylamide monomer compounds.

Examples of acrylamide (2C) include 4-acryloylmorpholine (ACMO™), N,N-dimethylacrylamide (DMAA™), or a combination thereof. Other examples of functional acrylate monomers that may be used with the compositions described include N-vinylpyrrolidone (NVP), (N-(2-Hydroxyethyl) acrylamide) (HEAA™), 2-hydroxyethyl acrylate, diacetone acrylamide (DAAM™), N,N-diethylacrylamide (DEAA™), allyl acetate (AAc), 2(2-ethoxyethoxy)-ethyl acrylate, polyethyelene glycol (350) acrylate, or a combination thereof.

In one or more implementations, the at least one acrylamide monomer compound has an amide nitrogen as a member of a cyclic group. The cyclic group may be aromatic heterocyclic groups having from 4 to 20 atoms in the cyclic group; and saturated and unsaturated aliphatic heterocyclic groups having from 4 to 20 atoms in the cyclic group. The cyclic group may contain additional hetero atoms such as N, O, S, P, and Si other than the amide nitrogen atom. The cyclic group may be optionally substituted with groups selected from alkyl groups of 1 to 6 carbon atoms, hydroxyl, acyloxy, alkoxy of 1 to 6 carbon atoms, cyano, halo, phenyl, and benzo groups. In particular implementations, the acrylamide compound has the amide nitrogen as a member of a saturated and unsaturated aliphatic heterocyclic group having 4 to 20 atoms in the cyclic group. In more particular implementations, the acrylamide compound has a structure represented by the general formula (I).

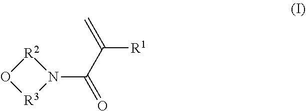

In the general formula (I), R¹ is a hydrogen or methyl group, R² and R³ are each independently and optionally substituted divalent hydrocarbon groups. In one or more examples, R² and R³ are each independently C1 to C10 optionally substituted divalent hydrocarbon groups. Examples of the divalent hydrocarbon groups include a methylene group, an ethylene group, and a trimethylene group. In one or more examples, R¹ is a hydrogen group and R² and R³ are ethylene groups. In one or more examples, R¹ is a methyl group and R² and R³ are ethylene groups.

In one or more implementations, which can be combined with other implementations, the acrylamide monomer compound refers to a compound having at least one group represented by CH₂+CR⁴—CO—N in each molecule, wherein R⁴ is a hydrogen or methyl group.

In one or more implementations, the acrylamide compound has a structure represented by the general formula (II).

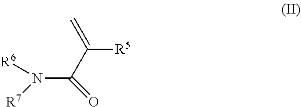

In the general formula (II), R⁵ is a hydrogen or methyl group, R⁶ and R⁷ are each independently and optionally unsubstituted hydrocarbon groups. In one or more examples, R⁶ and R⁷ are each independently C1 to C10 optionally unsubstituted hydrocarbon groups. Examples of the hydrocarbon groups include a methane group and an ethane group. In one or more examples, R⁵ is a hydrogen group and R⁶ and R⁷ are methane groups. In one or more examples, R⁵ is a hydrogen group and R⁶ and R⁷ are ethane groups.

Examples of commercially available acrylamide monomer compounds (2C) include ACMO™ and DMAA®, which are commercially available from KJ Chemicals Corporation.

There are several benefits of using the acrylamide monomer compounds (2C) in the porogen-forming composition including enhanced photocuring performance and water solubility. For example, in some implementations, the formulations including the acrylamide monomer compounds (2C) produce porogen-features, which are hard yet still water soluble.

If present, the acrylamide monomer compound (2C) generally is present in an amount in a range from about 50 wt. % to about 90 wt. %, or in a range from about 60 wt. % to about 80 wt. %, or in a range from about 70 wt. % to about 80 wt. %, or in a range from about 70 wt. % to about 75 wt. % based on a total weight of the porogen-forming composition.

In one or more implementations, which can be combined with other implementations, the porogen-forming composition further includes (2D) one or more nitrogen-containing monofunctional vinyl monomers. In one or more implementations, the porogen-forming compositions, which include the one or more nitrogen-containing monofunctional vinyl monomers (2D), further include comonomers that are either acrylate or acrylamide to facilitate homopolymerization of the one or more nitrogen-containing monofunctional vinyl monomers (2D).

Examples of nitrogen-containing monofunctional vinyl monomers (2D) include N-vinylcaprolactam (NVC), vinyl methyl oxazolidinone (VMOX), N-vinylformamide, N-vinylcarbazole, N-vinylacetamide, or N-vinylpyrrolidone (NVP), or a combination thereof.

There are several benefits of using the nitrogen-containing monofunctional vinyl monomers (2D) having in the porogen-forming composition including enhanced photocuring performance and water solubility.

If present, the nitrogen-containing monofunctional vinyl monomers (2D) generally is present in an amount in a range from about 70 wt. % to about 90 wt. % or in a range from about 85 wt. % to about 90 wt. % based on a total weight of the porogen-forming composition.

In one or more implementations, which can be combined with other implementations, the porogen-forming composition further includes (3) one or more dissolute compounds. The one or more dissolute compounds can include one or more of (3A) a polyhydroxy compound having two or more hydroxyl groups, and (3B) a cyclic carbonate ester.

In one or more implementations, which can be combined with other implementations, the porogen-forming composition further includes (3A) a polyhydroxy compound having two or more hydroxyl groups. The polyhydroxy compound (3A) includes a water-soluble polyhydroxy compound which does not possess any curable functional groups like ethylenically-unsaturated groups.

Examples of the polyhydroxy compound (3A) are water-soluble alkylene glycols such as ethylene glycol, propylene glycol and butanediol, polyhydric alcohols with three or more hydroxyl groups such as glycerol and diglycerol, and polyalkylene glycols [poly(oxyalkylene)glycols] such as polyethylene glycol [poly(oxyethylene) glycol], polypropylene glycol [poly(oxypropylene) glycol] and polyethylene glycol/polypropylene glycol copolymer, diethylene glycol, and one, two or more of these can be included.

In one or more implementations, the polyhydroxy compound (3A) is selected from polyethylene glycol having an average molecular weight in a range from about 400 g/mol to about 1000 g/mol or in a range from about 400 g/mol to about 600 g/mol, or about 400 g/mol, 600 g/mol, or 1000 g/mol.

In order to make the viscosity of the porogen-forming composition for the porogen regions a viscosity suitable for printing, making the porogen regions formed by photocuring readily water-soluble, and making it possible to achieve ready separation from the main pad body with an external force such as a water jet and/or mechanical abrasion, the molecular weight of polyhydroxy compound (3A) is generally no more than 2000 g/mol, for example, in a range from about 400 g/mol to about 1000 g/mol, or in a range from about 400 g/mol to about 600 g/mol.

Examples of commercially available polyhydroxy compounds which can be used as polyhydroxy compounds (3A) include Kollisolv® PEG 400, Kollisolv® PEG 600, and Kollisolv® PEG 1000, all of which are commercially available from BASF.

If present, the polyhydroxy compound (3A) generally is present in an amount in 90 wt. % or less, 80 wt. % or less, 70 wt. % or less, or in a range from about 50 wt. % to about 70 wt. %, or in a range from about 50 wt. % to about 60 wt. %, or in a range from about 60 wt. % to about 70 wt. % based on a total weight of the porogen-forming composition.

In one or more implementations, which can be combined with other implementations, the porogen-forming composition further includes (3B) a cyclic carbonate ester. The cyclic carbonate ester (3B) can include propylene carbonate.

Propylene carbonate is miscible with water and low in viscosity and thus may be used to adjust the viscosity of the formulation to the printable range.

If present, the cyclic carbonate ester (3B) generally is present in an amount in a range from about 0.1 wt. % to about 15 wt. %, or in a range from about 1 wt. % to about 10 wt. %, or in a range from about 5 wt. % to about 10 wt. % based on a total weight of the porogen-forming composition.

In one or more implementations, which can be combined with other implementations, the porogen-forming composition further includes (4) one or more photoinitiator components.

The photoinitiator component (4) may be any compound which initiates a radical polymerization reaction by means of light such as ultraviolet (UV), near ultraviolet, visible light, infrared or far infrared radiation, of the kind used in curing of the porogen-forming composition, and it is not particularly restricted, so conventional general-purpose photo-radical polymerization initiators can be employed.

Examples of photoinitiator component (4) include 1-hydroxycyclohexyl phenyl ketone, 2,2-dimethoxy-2-phenylacetophenone, xanthone, fluorenone, fluorene, anthraquinone, 3-methylacetophenone, 4-chlorobenzophenone, 4,4′-dimethoxybenzophenone, 4,4′-diaminobenzophenone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, 2-methyl-1-[4-(methylthio)phenyl]-2-morpholino-propan-1-one, 2,4,6-trimethylbenzoyldiphenylphosphine oxide, bis-(2,6-dimethoxybenzoyl)-2,4,4-trimethylpentylphosphine oxide, bis(2,4,6-trimethylbenzoyl)phenylphosphine oxide, 1-[4-(2-hydroxyethoxy)-phenyl]-2-hydroxy-2-methyl-1-propan-1-one, blends of 2,4,6-trimethylbenzoyl-diphenyl-phosphine oxide (50%) and 2-hydroxy-2-methyl-1pheylpropanone (50%) and the like, and it is possible to include one, two or more of these photoinitiators as the photoinitiator component (4) in the porogen-forming composition.

Examples of commercially available photoinitiator components which can be used as photoinitiator component (4) include Omnirad 184, Omnirad 369, Omnirad 651, Omnirad 500, Omnirad 819, Omnirad 907, Omnirad 1173, Omnirad 4265, which are commercially available from IGM Resins.

The photoinitiator component (4) generally is present in an amount in a range from about 0.1 wt. % to about 5 wt. %, or in a range from about 0.2 wt. % to about 4 wt. %, or in a range from about 1 wt. % to about 2 wt. % based on a total weight of the porogen-forming composition.

The photocurable printing composition may further include additional additives. Additional additives may include, for example, one or more emulsifiers/surfactants, one or more stabilizers (e.g., butylated hydroxytoluene “BHT”), fillers (e.g., polyvinylpyrrolidone), antioxidants, inhibitors (e.g. MEHq stabilizer for free radical cure), leveling agents, and sacrificial materials.

Advantages of the implementations described herein are further illustrated by the following examples. The particular materials and amounts thereof, as well as other conditions and details, recited in these examples should not be used to limit the implementations described herein. Examples of the present disclosure are identified by the letter “E” followed by the sample number while comparative examples, which are not examples of the present disclosure are designated by the letter “X” followed by the sample number.

As noted above, in some implementations, one or more of the materials that are used to form at least one of the polishing elements, such as the polishing elements 304, the foundation layer 302, or both, is formed by sequentially depositing and post deposition processing of at least one photocurable porogen-forming printing composition. In at least one implementation, the components of the photocurable porogen-forming printing composition are mixed during the precursor formulation process performed in the additive manufacturing system 600. Examples of some of these components are listed in Table I.

### EXAMPLES

The following non-limiting examples are provided to further illustrate implementations described herein. However, the examples are not intended to be all-inclusive and are not intended to limit the scope of the implementations described herein. The particular materials and amounts thereof, as well as other conditions and details, recited in these examples should not be used to limit the implementations described herein.

Examples of various functional oligomers can be found in items O1 and O2 of Table I. Example of acrylate-based monomers can be found in items M1-M7 of Table 1. Examples of dissolutes can be found in items D1-D7 of Table 1. Examples of photoinitiators can be found in items PI1-PI3 of Table 1. Examples of additional additives can be found in items S1-S2 of Table I.

TABLE I

| Reference | Material | | Polymer | Viscosity | | |
|---|---|---|---|---|---|---|
| Name | Information | Functionality | Tg (° C.) | (cP) | MW | |
| O1 | Water-soluble | 2 | | 1500 at | 750 | MIRAMER |
| | Aliphatic Alkyl | | | 25° C. | | PE220 |
| | Epoxy Difunctional | | | | | |
| | Acrylate Oligomer | | | | | |
| O2 | Acid Acrylate | 1 | 18 | 115 at | | CN147 |
| | Oligomer | | (by DSC) | 25° C. | | |
| M1 | Methoxy | 1 | −57 | 22 at | 404 | SR551 |
| | Polyethylene | | (by DSC) | 25° C. | | (PEG(350) |
| | Glycol (350) | | | | | acrylate |
| | Monoacrylate | | | | | monomer) |
| M2 | Methoxy | 1 | −50 | 50 at | 604 | SR553 |
| | Polyethylene | | (by DSC) | 25° C. | | (PEG(550) |
| | Glycol (550) | | | | | acrylate |
| | Monoacrylate | | | | | monomer) |
| M3 | Polyethylene | 2 | −42 | 90 at | 708 | SR610 |
| | Glycol (600) | | (by DSC) | 25° C. | | (PEG(600) |
| | Diacrylate | | | | | diacrylate) |
| M4 | Ethoxylated (15) | 3 | −32 | 168 at | 945 | SR9035 |
| | Trimethylolpropane | | (by DSC) | 25° C. | | |
| | Triacrylate | | | | | |
| M5 | Ethoxylated (30) | 2 | −42 | 680 at | 1658 | SR9038 |
| | Bisphenol A | | (by DSC) | 25° C. | | |
| | Diacrylate | | | | | |
| M6 | N,N-Dimethyl | 1 | 119 | 1.19 at | 99 | DMAA ™ |
| | acrylamide | | | 20° C. | | |
| M7 | Acryloyl | 1 | 145 | 9-12 at | 141 | ACMO ™ |
| | morphiline | | | 25° C. | | |
| M8 | N-vinylpyrrolidone | 1 | | 2.4 at | 111.1 | NVP |
| | | | | 20° C. | | |
| M9 | Vinyl methyl | 1 | | 4.4 at | | VMOX |
| | oxazolidinone | | | 20° C. | | |
| D1 | Polyethylene | 0 | | 105-130 at | 380 to 420 | PEG400 |
| | glycol 400 | | | 25° C. | (400) | |
| | (liquid) | | | | | |
| D2 | Polyethylene | 0 | | Solid | 570 to 630 | PEG600 |
| | glycol 600 | | | | (600) | |
| | (solid) | | | | | |
| D3 | Polyethylene | 0 | | Solid | 900 to 1100 | PEG1000 |
| | glycol 1000 | | | | (1000) | |
| | (solid) | | | | | |
| D4 | Diethylene | 0 | | | 106 | DEG |
| | glycol | | | | | |
| D5 | Propylene | 0 | | | 76 | PPG |
| | glycol | | | | | |
| D6 | Propylene | | | | 102 | PC |
| | Carbonate | | | | | |
| D7 | Glycerol | | | | 92 | |
| PI1 | Bis(2,4,6- | | | | 418.5 | (Omnirad ® |
| | Trimethylbnzoyl) | | | | | 819) |
| | phenylphospine | | | | | |
| | oxide | | | | | |
| PI2 | 2-Hydroxy-2- | | | | 164.20 | (Omnirad ® |
| | methyl-1-phenyl- | | | | | 1173) |
| | propan-1-one | | | | | |
| PI3 | Diphenyl(2,4,6- | | | | 348.37 | (Omnirad ® |
| | trimethylbenzoyl) | | | | | 4265) |
| | phosphine | | | | | |
| | oxide | | | | | |
| S1 | Butylated | | | | 220.356 | |
| | Hydroxytoluene | | | | | |
| | (BHT) | | | | | |
| S2 | Polyvinylpyrrolidone | | | | 9,700 | PVP |

Examples of formulations for forming the porogen-regions of the polishing pads described herein are illustrated below in Table II to Table V.

In one or more implementations, the photocurable porogen-forming printing composition may comprise, consist essentially of, or consist of one or more of: one or more polyfunctional (meth)acrylate monomer compounds having at least one (meth)acryloyloxy group; (3) one or more unreactive dissolute compounds including one or more of (3A) a polyhydroxy compound having two or more hydroxyl groups, and (3B) a cyclic carbonate ester; (4) one or more photoinitiator components; and optionally (5) additional additives.

A content of the polyfunctional (meth)acrylate monomer compound with respect to the total weight of the porogen-forming printing composition may be about 10 wt. % or greater, or about 20 wt. % or greater, or in a range from about 20 wt. % to about 40 wt. %, or in a range from about 20 wt. % to about 30 wt. %, or in a range from about 25 wt. % to about 30 wt. %. A content of the polyhydroxy compound having two or more hydroxyl groups with respect to the total weight of the porogen-forming printing composition may be less than 90 wt. %, or less than 80 wt. %, or less than 70 wt. %, or in a range from about 60 wt. % to about 80 wt. %, or in a range from about 60 wt. % to about 70 wt. %. A content of the photoinitiator component with respect to the total weight of the porogen-forming printing composition may be in a range from about 0.1 wt. % to about 5 wt. %, or in a range from about 0.2 wt. % to about 4 wt. %, or in a range from about 1 wt. % to about 2 wt. % based on a total weight of the photocurable porogen-forming printing composition. A content of the cyclic ester component with respect to the total weight of the porogen-forming printing composition may be in a range from about 0.1 wt. % to about 15 wt. %, or in a range from about 1 wt. % to about 10 wt. %, or in a range from about 5 wt. % to about 10 wt. %.

Referring to Table II, in one or more examples, the photocurable porogen-forming printing composition includes a polyhydroxy compound having two or more hydroxyl groups, for example, polyethylene glycol 400, one or more (meth)acrylate monomer compounds having at least one (meth)acryloyloxy group, for example, a polyethylene glycol diacrylate cross-linker such as polyethylene glycol (600) diacrylate, and a photoinitiator. The photocurable porogen-forming printing composition may further include propylene carbonate. The photocurable porogen-forming printing composition may further include propylene carbonate and butylated hydroxytoluene.

TABLE II

| | Material Information | Formulation | Viscosity |
|---|---|---|---|
| Item No. | (See Table 1 Ref. Name) | Composition | (cP, 70° C.) |
| E1-1 | D1:M3:PI2 | 70:30:2 | 15.37 |
| E1-2 | D1:M3:D6:P12 | 64:27:9:2 | 11.97 |
| E1-3 | D1:M3:S1:D6:PI2 | 64:27:0.2:9:2 | 12.27 |

In one or more implementations, the photocurable porogen-forming printing composition may comprise, consist essentially of, or consist of one or more of: (1) an acidic acrylate oligomer; (2A) one or more monofunctional (meth)acrylate compounds and/or polyfunctional acrylate compounds; (3) one or more unreactive dissolute compounds including one or more of (3A) a polyhydroxy compound having two or more hydroxyl groups; and (4) one or more photoinitiator components.

A content of the acidic acrylate oligomer with respect to the total weight of the porogen-forming printing composition may be about 1 wt. % to about 30 wt. %, or in a range from about 5 wt. % to about 20 wt. %, or in a range from about 10 wt. % to about 20 wt. %, or in a range from about 15 wt. % to about 20 wt. %. A content of the polyfunctional (meth)acrylate monomer compound with respect to the total weight of the porogen-forming printing composition may be in a range from about 1 wt. % to about 25 wt. %, or in a range from about 5 wt. % to about 20 wt. %, or in a range from about 5 wt. % to about 10 wt. %. A content of the monofunctional (meth)acrylate monomer compound with respect to the total weight of the porogen-forming printing composition may be in a range from about 1 wt. % to about 25 wt. %, or in a range from about 5 wt. % to about 20 wt. %, or in a range from about 10 wt. % to about 20 wt. %. A content of the polyhydroxy compound having two or more hydroxyl groups with respect to the total weight of the porogen-forming printing composition may be 90 wt. % or less, 80 wt. % or less, 70 wt. % or less, or in a range from about 50 wt. % to about 90 wt. %, or in a range from about 70 wt. % to about 90 wt. %, or in a range from about 50 wt. % to about 60 wt. %. A content of the photoinitiator component with respect to the total weight of the porogen-forming printing composition may be in a range from about 0.1 wt. % to about 5 wt. %, or in a range from about 0.2 wt. % to about 4 wt. %, or in a range from about 1 wt. % to about 2 wt. %. A content of the cyclic ester component with respect to the total weight of the porogen-forming printing composition may be in a range from about 0.1 wt. % to about 15 wt. %, or in a range from about 1 wt. % to about 10 wt. %, or in a range from about 5 wt. % to about 10 wt. %.

Referring to Table III, in one or more examples, the photocurable porogen-forming printing composition includes one or more functional acrylate oligomer components, for example, an acidic acrylate oligomer having a functionality of one, one or more (meth)acrylate monomer compounds having at least one (meth)acryloyloxy group, for example, a methoxy polyethylene glycol monoacrylate, for example, PEG (350) monoacrylate, a polyethylene glycol diacrylate cross-linker, for example, PEG (600) diacrylate, one or more dissolute compounds including a polyhydroxy compound having two or more hydroxyl groups, for example, polyethylene glycol 400 and one or more photoinitiator components. The photocurable porogen-forming printing composition may further include propylene carbonate, glycerol, or both propylene carbonate and glycerol.

TABLE III

| | Material Information | Formulation | Viscosity | Cure |
|---|---|---|---|---|
| Item No. | (See Table 1 Ref. Name) | Composition | (cP, 70° C.) | Properties |
| E2-1 | O2:M3:D1:PI1 | 20:20:58:2 | | Solid |
| E2-2 | O2:M1:D1:PI1 | 20:20:58:2 | | Liquid/Gel |
| E2-3 | O2:M3:M1:D1:PI1 | 20:10:10:58:2 | | Solid (easily |
| | | | | crushed) |
| E2-4 | O2:M1:D1:D7:PI1 | 20:20:28:30:2 | | Gel Adhesive |
| E2-5 | O2:M3:D1:PI2 | 10:10:78:2 | | Hard Solid |
| E2-6 | O2:M3:D1:PI2 | 5:10:83:2 | 15.66 | Solid |
| E2-7 | O2:M3:D1:PI2 | 10:5:83:2 | | Solid (sticky |
| | | | | when crushed) |
| E2-8 | O2:M3:D1:PI2 | 5:5:89:2 | | Gel |
| E2-9 | O2:M3:D1:D6:PI2 | 4.5:9:74.7:10:1.8 | 12.27 | Gel |

The photocurable porogen-forming printing composition may comprise, consist essentially of, or consist of one or more of: (2C) one or more acrylamide monomer compounds; and (2D) one or more nitrogen-containing monofunctional vinyl monomers; (3) one or more dissolute compounds including (3A) a polyhydroxy compound having two or more hydroxyl groups; (4) one or more photoinitiator components; and/or (5) additional additives. The photocurable porogen-forming printing composition may further include a monofunctional (meth)acrylate monomer compound.

A content of one or more acrylamide monomer compounds with respect to the total weight of the porogen-forming printing composition may be about 50 wt. % to about 90 wt. %, or in a range from about 60 wt. % to about 80 wt. %, or in a range from about 70 wt. % to about 80 wt. %, or in a range from about 70 wt. % to about 75 wt. %. A content of one or more nitrogen-containing monofunctional vinyl monomers with respect to the total weight of the porogen-forming printing composition may be about 50 wt. % to about 90 wt. %, or in a range from about 60 wt. % to about 80 wt. %, or in a range from about 70 wt. % to about 80 wt. %, or in a range from about 70 wt. % to about 75 wt. %. A content of the polyhydroxy compound having two or more hydroxyl groups with respect to the total weight of the porogen-forming printing composition may be in a range from about 5 wt. % to about 50 wt. %, or in a range from about 10 wt. % to about 40 wt. %, or in a range from about 10 wt. % to about 20 wt. %. A content of the monofunctional (meth)acrylate monomer compound with respect to the total weight of the porogen-forming printing composition may be in a range from about 0.1 wt. % to about 20 wt. %, or in a range from about 1 wt. % to about 10 wt. %, or in a range from about 5 wt. % to about 10 wt. %. A content of the photoinitiator component with respect to the total weight of the porogen-forming printing composition may be in a range from about 0.1 wt. % to about 5 wt. %, or in a range from about 0.2 wt. % to about 4 wt. %, or in a range from about 1 wt. % to about 2 wt. %. A content of an additional component such as polyvinylpyrrolidone to the total weight of the porogen-forming printing composition may be in a range from about 0.1 wt. % to about 20 wt. %, or in a range from about 1 wt. % to about 15 wt. %, or in a range from about 10 wt. % to about 15 wt. %.

Referring to Table IV, in one or more examples, the photocurable porogen-forming printing composition includes one or more acrylamide monomer compounds, for example, ACMOT, DMAAT, or mixtures of ACMOT and DMAA™; one or more nitrogen-containing monofunctional vinyl monomers, for example, NVP, VMOX, or mixtures of NVP and VMOX; one or more dissolute compounds including a polyhydroxy compound having two or more hydroxyl groups, for example, polyethylene glycol 400, polyethylene glycol 600, or mixtures of polyethylene glycol 400 and polyethylene glycol 600, and one or more photoinitiator components. The photocurable porogen-forming printing composition may further include methoxy polyethylene glycol (350) monoacrylate, methoxy polyethylene glycol (550) monoacrylate, or both methoxy polyethylene glycol (350) monoacrylate and methoxy polyethylene glycol (550) monoacrylate. The photocurable porogen-forming printing composition may further include polyvinylpyrrolidone.

TABLE IV

| | Material Information | Formulation | | | |
|---|---|---|---|---|---|
| Item No. | (See Table 1 Ref. Name) | Composition | Viscosity | Curing | Shore D |
| E3-1 | M6:D1:PI2 | 20:78:2 | | gel | |
| E3-2 | M6:D1:PI2 | 30:68:2 | | gel | |
| E3-3 | M6:D1:PI2 | 40:58:2 | | gel | |
| E3-4 | M6:M1:D1:PI2 | 20:20:58:2 | | gel | |
| E3-5 | M6:D1:PI2 | 90:8:2 | | hard plastic | 69 |
| E3-6 | M6:D1:PI2 | 70:28:2 | | tough gel, | |
| | | | | sticky when | |
| | | | | warm | |
| E3-7 | M6:M2:D1:PI2 | 70:20:8:2 | | Hard plastic | 12 |
| E3-8 | M6:M2:D1:PI2 | 50:40:8:2 | | tough | |
| | | | | elastomer | |
| E3-9 | M7:D1:PI2 | 50:48:2 | | tough | |
| | | | | elastomer | |
| E3-10 | M7:D1:PI2 | 90:8:2 | | tough | 77 |
| | | | | plastic | |
| E3-11 | M7:D1:PI2 | 90:8:2 | 12.71 cP at | | 77 |
| | | | 25° C. | | |
| E3-12 | M7:D1:PI2 | 70:28:2 | 20.97 cP at | Sticky when | 41 |
| | | | 25° C. | warm, | |
| | | | | shore D | |
| | | | | when cold | |
| E3-13 | M6:D2:PI3 | 50:48:2 | | | |
| E3-14 | M6:D2:PI3 | 70:28:2 | 4.14 cP at | Tacky when | 17 |
| | | | 25° C. | warm, hard | |
| | | | | when cold | |
| E3-15 | M6:D3:PI3 | 50:48:2 | 13.3 cP at | | 40 |
| | | | 25° C. | | |
| E3-16 | M6:D3:PI3 | 70:28:2 | | | 18 |
| E3-17 | M7:D2:PI3 | 70:28:2 | 23.64 cP at | Surface soft | 60 |
| | | | 25° C. | when warm | |
| E3-18 | M7:D3:PI3 | 70:28:2 | 31.62 cP at | White hard | 65 |
| | | | 25° C. | plastic | |
| E3-19 | M7:D2:S2:PI3 | 70:17:11:2 | 12.94 | Shore D 51 | |
| E-3-19 + | M7:D2:S2:PI3:S1 | 70:17:11:2:0.2 | 12.94 | Partial gel | |
| 0.2% BHT | | | | | |
| E-3-19 + | M7:D2:S2:PI3:S1 | 70:17:11:2:0.4 | 12.94 | | |
| 0.4% BHT | | | | | |

The photocurable porogen-forming printing composition may comprise, consist essentially of, or consist of one or more of: (1) one or more functional water-soluble acrylate oligomer components; (2) an acrylate monomer mixture including one or more of (2A) one or more monofunctional (meth)acrylate compounds and/or polyfunctional acrylate compounds; (2C) one or more acrylamide monomer compounds; and (2D) one or more nitrogen-containing monofunctional vinyl monomers; (3) one or more dissolute compounds including (3A) a polyhydroxy compound having two or more hydroxyl groups; (4) one or more photoinitiator components; and/or (5) additional additives.

A content of the water-soluble acrylate oligomer component with respect to the total weight of the porogen-forming printing composition may be about 1 wt. % to about 30 wt. %, or in a range from about 5 wt. % to about 20 wt. %, or in a range from about 10 wt. % to about 20 wt. %, or in a range from about 15 wt. % to about 20 wt. %. A content of the monofunctional (meth)acrylate monomer compound with respect to the total weight of the porogen-forming printing composition may be in a range from about 10 wt. % to about 40 wt. %, or in a range from about 10 wt. % to about 30 wt. %, or in a range from about 20 wt. % to about 30 wt. %. A content of the polyfunctional (meth)acrylate monomer compound with respect to the total weight of the porogen-forming printing composition may be in a range from about 1 wt. % to about 20 wt. %, or in a range from about 5 wt. % to about 20 wt. %, or in a range from about 10 wt. % to about 15 wt. %. A content of the polyhydroxy compound having two or more hydroxyl groups with respect to the total weight of the porogen-forming printing composition may be 90 wt. % or less, 80 wt. % or less, 70 wt. % or less, or in a range from about 50 wt. % to about 70 wt. %, or in a range from about 50 wt. % to about 60 wt. %, or in a range from about 60 wt. % to about 70 wt. %. A content of the photoinitiator component with respect to the total weight of the porogen-forming printing composition may be in a range from about 0.1 wt. % to about 5 wt. %, or in a range from about 0.2 wt. % to about 4 wt. %, or in a range from about 1 wt. % to about 2 wt. % based on a total weight of the photocurable porogen-forming printing composition.

Referring to Table V, in one or more examples, the photocurable porogen-forming printing composition includes one or more functional acrylate oligomer components, for example, a water-soluble aliphatic alkyl epoxy difunctional acrylate oligomer, one or more (meth)acrylate monomer compounds having at least one (meth)acryloyloxy group, for example, a methoxy polyethylene glycol monoacrylate, such as one or more of PEG (350) monoacrylate and PEG (550) monoacrylate, one or more acrylamide monomer compounds, for example, DMAA, one or more dissolute compounds including a polyhydroxy compound having two or more hydroxyl groups, for example, one or more of polyethylene glycol 400, diethylene glycol, and glycerol, and one or more photoinitiator components.

TABLE V

| Item | Material Information (See | Formulation | | | Shore |
|---|---|---|---|---|---|
| No. | Table 1 Ref. Name) | Composition | Viscosity | Curing | A |
| E4-1 | O1:M1:D1:PI2 | 20:20:58:2 | | Hard, tacky | |
| | | | | surface | |
| E4-2 | O1:M1:D1:PI2 | 10:20:68:2 | | Hard, tacky | |
| | | | | surface | |
| E4-3 | O1:M1:D1:PI2 | 15:20:63:2 | | Hard, tacky | |
| | | | | surface | |
| E4-4 | O1:M1:D1:D4:PI2 | 15:20:23:40:2 | | Hard, tacky | |
| | | | | surface | |
| E4-5 | O1:M2:D1:PI2 | 15:20:63:2 | 16.4 | Hard, dry | |
| | | | | surface | |
| E4-6 | O1:M1:D1:D7:PI2 | 15:20:33:30:2 | | | |
| E4-7 | O1:M1:D1:D4:PI2 | 15:20:43:20:2 | | Hard, tacky | |
| | | | | surface | |
| E4-8 | O1:M2:D1:D4:PI2 | 15:20:43:20:2 | 13.45 | Hard, dry | |
| | | | | surface | |
| E4-9 | O1:M2:D1:D4:PI2 | 10:30:38:20:2 | | Soft | |
| E4-10 | O1:M2:D1:PI2 | 20:20:58:2 | | | |
| E4-11 | O1:M2:D1:PI2 | 15:30:53:2 | | Hard | 5.6 |
| E4-12 | O1:M2:M6:D1:PI2 | 15:20:10:53:2 | | | 10.8 |
| E4-13 | O1:M2:M6:D1:PI2 | 10:20:10:48:2 | | Hard but | |
| | | | | brittle | |

The photocurable porogen-forming printing composition may comprise, consist essentially of, or consist of one or more of: (2) an acrylate monomer mixture including one or more of (2A) one or more (meth)acrylate monomer compounds having at least one (meth)acryloyloxy group, (2B) one or more ethoxylated acrylate monomer compounds, and (2C) one or more acrylamide monomer compounds; (3) one or more dissolute compounds including (3A) a polyhydroxy compound having two or more hydroxyl groups, and (3B) a cyclic carbonate ester; and/or (4) one or more photoinitiator components.

A content of the one or more ethoxylated acrylate monomer compounds with respect to the total weight of the porogen-forming printing composition may be about 1 wt. % to about 20 wt. %, or in a range from about 5 wt. % to about 20 wt. %, or in a range from about 10 wt. % to about 20 wt. %, or in a range from about 10 wt. % to about 15 wt. %. A content of the monofunctional (meth)acrylate monomer compound with respect to the total weight of the porogen-forming printing composition may be in a range from about 10 wt. % to about 30 wt. %, or in a range from about 10 wt. % to about 20 wt. %, or in a range from about 20 wt. % to about 30 wt. %, or in a range from about 15 wt. % to about 25 wt. %, or about 20 wt. %. A content of the one or more acrylamide monomer compounds with respect to the total weight of the porogen-forming printing composition may be in a range from about 10 wt. % to about 50 wt. %, or in a range from about 10 wt. % to about 40 wt. %, or in a range from about 20 wt. % to about 30 wt. %. A content of the polyhydroxy compound having two or more hydroxyl groups with respect to the total weight of the porogen-forming printing composition may be 90 wt. % or less, 80 wt. % or less, 70 wt. % or less, or in a range from about 50 wt. % to about 70 wt. %, or in a range from about 50 wt. % to about 60 wt. %, or in a range from about 60 wt. % to about 70 wt. %. A content of the cyclic ester component with respect to the total weight of the porogen-forming printing composition may be in a range from about 0.1 wt. % to about 15 wt. %, or in a range from about 1 wt. % to about 10 wt. %, or in a range from about 5 wt. % to about 10 wt. %. A content of the photoinitiator component with respect to the total weight of the porogen-forming printing composition may be in a range from about 0.1 wt. % to about 5 wt. %, or in a range from about 0.2 wt. % to about 4 wt. %, or in a range from about 1 wt. % to about 2 wt. %.

Referring to Table VI, in one or more examples, the photocurable porogen-forming printing composition includes an ethoxylated acrylate monomer compound, for example, ethoxylated (30) Bisphenol A Diacrylate, one or more (meth)acrylate monomer compounds, for example, methoxy polyethylene glycol (350) monoacrylate or methoxy polyethylene glycol (550) monoacrylate, one or more acrylamide monomer compounds, for example, DMAA, one or more dissolute compounds including a polyhydroxy compound having two or more hydroxyl groups, for example, one or more of polyethylene glycol 400, polyethylene glycol 600, polyethylene glycol 1000, propylene glycol, and glycerol, a cyclic carbonate ester, for example, propylene carbonate, and one or more photoinitiator components.

TABLE VI

| Item | Material Information (See | Formulation | Viscosity | | Shore |
|---|---|---|---|---|---|
| No. | Table 1 Ref. Name) | Composition | (cP, 70° C.) | Curing | A |
| E5-1 | M5:M6:D1:PI2 | 10:20:68:2 | | Solid | 5 |
| E5-2 | M5:M6:D1:PI2 | 10:50:38:2 | | too resilient | |
| E5-3 | M5:M6:D1:PI2 | 5:30:63:2 | | Solid | 5 |
| E5-4 | M5:M2:D1:PI2 | 15:20:63:2 | 18.9 | | |
| E5-5 | M5:M2:D1:PI2 | 10:20:68:2 | 16.99 | | |
| E5-6 | M5:M2:D1:D5:PI2 | 10:20:58:10:2 | 15.22 | | |
| E5-7 | M5:M2:D1:D5:PI2 | 10:20:48:20:2 | 13.45 | | 1 |
| E5-8 | M5:M2:D1:D5:PI2 | 15:20:38:30:2 | 13.15 | | |
| E5-9 | M5:M2:D1:D6:PI2 | 15:20:48:20:2 | 11.67 | | |
| E5-10 | M5:M2:D1:D6:PI2 | 10:20:60:8:2 | 14.04 | | |
| E5-11 | M5:M2:D1:D6:PI3 | 10:20:58:10:2 | 13.89 | | |
| E5-12 | M5:M2:D1:D6:PI1 | 10:20:58:10:2 | | | |
| E5-13 | M5:M2:D3:D7:D5:PI3 | 10:20:20:20:28:2 | 21.52 | Soft White | |
| | | | | coupon | |
| E5-14 | M5:M2:D2:D7:D5:PI3 | 10:20:20:20:28:2 | | Soft White | |
| | | | | coupon | |
| E5-15 | M5:M1:D2:D7:D5:PI3 | 10:20:20:20:28:2 | | Soft White | |
| | | | | coupon | |
| E5-16 | M5:M2:D2:D5:PI3 | 10:20:40:28:2 | 11.63 | | |
| E5-17 | M5:M2:D3:D5:PI3 | 10:20:40:28:2 | | | |
| E5-18 | M5:M2:D2:D7:D5:PI3 | 10:20:43:5:20:2 | 17.01 | Shore Test | |
| | | | | breaks | |
| E5-19 | M5:M2:D2:D7:D5:PI3 | 13:20:40:3:22:2 | 16.86 | Shore Test | |
| | | | | breaks | |
| E5-20 | M5:M2:D3:D7:D5:PI3 | 12:20:20:10:36:2 | 29.08 | White coupon | |

In one or more implementations that can be combined with other implementations, the porogen-forming compositions of the present disclosure have values of glass transition temperature (T_{g}) that are greater than T_{g} values for conventional formulations. In some implementations, T_{g} values for the porogen-forming composition disclosed herein are about 80° C. or more, such as about 80° C. to about 200° C., such as about 80° C. to about 160° C., such as about 80° C. to about 120° C., such as about 80° C. to about 100° C., such as about 80° C. to about 90° C., such as about 85° C. In some implementations, the greater T_{g} values of the porogen-forming compositions correlate to polishing pad materials that maintain consistent material properties and stable performance over a wider temperature range, including at higher temperatures, compared to conventional pad materials.

The hardness of the materials in a polishing pad plays a role in the polishing uniformity results found on a substrate after polishing and the rate of material removal. Hardness of a material, also often measured using a Rockwell, Ball or Shore hardness scale, measures a materials resistance toward indentation and provides an empirical hardness value, and may track or increase with increasing storage modulus E′. Pad materials are typically measured using a Shore hardness scale, which is typically measured using the ASTM D2240 technique. Typically, pad material hardness properties are measured on either a Shore A or Shore D scale, which is commonly used for softer or low storage modulus E′ polymeric materials, such as polyolefins. Rockwell hardness (e.g., ASTM D785) testing may also be used to test the hardness of “hard” rigid engineering polymeric materials, such as a thermoplastic and thermoset materials.

In one or more implementations that can be combined with other implementations, the porogen-features formed using the porogen-forming compositions of the present disclosure have a hardness value in a range from about 10 Shore D scale to about 90 Shore D scale, or in a range from about 40 Shore D scale to about 90 Shore D scale, or in a range from about 40 Shore D scale to about 60 Shore D scale, or in a range from about 40 Shore D Scale to about 50 Shore D scale, or in a range from about 70 Shore D scale to about 80 Shore D scale.

In one or more implementations that can be combined with other implementations, the porogen-features formed using the porogen-forming compositions of the present disclosure have values for storage modulus E′ at a temperature of about 70° C. (E′70) maintained above a target value, such as about 200 MPa or greater, which is similar to the values for storage modulus of pad-forming materials. In some implementations, E′70 target values for some porogen-features disclosed herein are about 200 MPa or greater, such as about 210 MPa or greater, such as about 220 MPa or greater, such as about 230 MPa or greater, such as about 240 MPa or greater, such as about 250 MPa or greater, or in a range from about 200 MPa to about 210 MPa, or in a range from about 210 MPa to about 220 MPa, or in a range from about 220 MPa to about 230 MPa, or in a range from about 230 MPa to about 240 MPa, or in a range from about 240 MPa to about 250 MPa, or about 200 MPa, 210 MPa, 220 MPa, 230 MPa, 240 MPa, or about 250 MPa.

The previously described implementations of the present disclosure have many advantages. However, the present disclosure does not require that all the advantageous features and all the advantages need to be incorporated into every implementation of the present disclosure. The porogen-features formed by photocuring of the porogen-forming compositions provide structural support to the formed polishing pad and are readily dissolvable in water. During a polishing process, the exposed porogen-features of the polishing can be easily separated from and removed from the pad by exposure to water-based solutions, mechanical abrasion, or a combination of exposure to both water-based solutions and mechanical abrasion. In this way, the porogen-features are removable to form pore-features of dimensional accuracy. Thus, the porogen-features formed using the porogen-forming compositions described provide enough structural support to the formed polishing pad to maintain pad integrity while also being easily removable from the polishing pad to achieved targeted porosity of the polishing pad.

In the Summary and in the Detailed Description, and the claims, and in the accompanying drawings, reference is made to particular features (including method steps) of the present disclosure. It is to be understood that the disclosure in this specification includes all possible combinations of such particular features. For example, where a particular feature is disclosed in the context of a particular aspect or implementation of the present disclosure, or a particular claim, that feature can also be used, to the extent possible in combination with and/or in the context of other particular aspects and implementations of the present disclosure, and in the present disclosure generally.

The term “at least” followed by a number is used herein to denote the start of a range beginning with that number (which may be a range having an upper limit or no upper limit, depending on the variable being defined). For example, “at least 1” means 1 or more than one. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

Embodiments and all of the functional operations described in this specification can be implemented in digital electronic circuitry, or in computer software, firmware, or hardware, including the structural means disclosed in this specification and structural equivalents thereof, or in combinations of them. Embodiments described herein can be implemented as one or more non-transitory computer program products, i.e., one or more computer programs tangibly embodied in a machine readable storage device, for execution by, or to control the operation of, data processing apparatus, e.g., a programmable processor, a computer, or multiple processors or computers.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. Processors suitable for the execution of a computer program include, by way of example, both general and special purpose microprocessors, and any one or more processors of any kind of digital computer.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The term “comprises,” “including,” and “having” and grammatical equivalents thereof are used herein to mean that other components, ingredients, operations, etc. are optionally present. For example, an article “comprising” (or “which comprises”) components A, B, and C can consist of (i.e., contain only) components A, B, and C, or can contain not only components A, B, and C but also one or more other components. In addition, whenever a composition, an element or a group of elements is preceded with the transitional phrase “comprising” or grammatical equivalents thereof, it is understood that it is contemplated that the same composition or group of elements may be preceded with transitional phrases “consisting essentially of,” “consisting of,” “selected from the group of consisting of,” or “is” preceding the recitation of the composition, element, or elements and vice versa.

Where reference is made herein to a method comprising two or more defined operations, the defined operations can be carried out in any order or simultaneously (except where the context excludes that possibility), and the method can include one or more other operations which are carried out before any of the defined operations, between two of the defined operations, or after all of the defined operations (except where the context excludes that possibility).

When introducing elements of the present disclosure or exemplary aspects or embodiment(s) thereof, the articles “a,” “an,” “the” and “said” are intended to mean that there are one or more of the elements.

While the foregoing is directed to embodiments of the present disclosure, other and further embodiments of the disclosure may be devised without departing from the basic scope thereof, and the scope thereof is determined by the claims that follow.

1. A curable porogen-forming composition used in forming removable porogen-features when producing a photochemically fabricated polishing article by an additive manufacturing process, the curable porogen-forming composition, in proportions based on a total weight of the curable porogen-forming composition, comprising:
(A) from about 60 to about 80 wt. % of an acrylamide monomer compound selected from 4-acryloylmorpholine, N, N-dimethylacrylamide, or a combination thereof;
(B) from about 10 to about 40 wt. % of a polyhydroxy compound having two or more hydroxyl groups; and
(C) from about 0.2 wt. % to about 4 wt. % of a photoinitiator component.

2. The composition of claim 1, further comprising:
(D) from about 10 wt. % to about 20 wt. % of polyvinylpyrrolidone.

3. The composition of claim 1, wherein the acrylamide monomer compound is 4-acryloylmorpholine.

4. The composition of claim 1, wherein the acrylamide monomer compound is N,N-dimethylacrylamide.

5. The composition of claim 1, wherein the polyhydroxy compound having two or more hydroxyl groups is a water-soluble polyhydroxy compound which does not possess any curable functional groups.

6. The composition of claim 1, wherein the polyhydroxy compound having two or more hydroxyl groups has a molecular weight in a range from about 400 g/mol to about 1000 g/mol.

7. The composition of claim 1, comprising from about 70 wt. % to about 80 wt. % of the acrylamide monomer compound and from about 10 wt. % to about 20 wt. % of the polyhydroxy compound having two or more hydroxyl groups.

8. A method of forming a polishing pad, comprising:
sequentially forming a plurality of polymer layers, wherein forming the plurality of polymer layers comprises:
forming a first layer of the polishing pad, wherein forming the first layer, comprises:
dispensing one or more droplets of a first pre-polymer composition via an additive manufacturing process on a surface on which the first layer is formed;
dispensing one or more droplets of a curable porogen-forming composition via the additive manufacturing process on the surface on which the first layer is formed, the curable porogen-forming composition, comprising:
(A) from about 60 to about 80 wt. % of an acrylamide monomer compound selected from 4-acryloylmorpholine, N, N-dimethylacrylamide, or a combination thereof;
(B) from about 10 to about 40 wt. % of a polyhydroxy compound having two or more hydroxyl groups; and
(C) from about 0.2 wt. % to about 4 wt. % of a photoinitiator component; and
at least partially curing the dispensed droplets of the first pre-polymer composition and the curable porogen-forming composition to form the first layer of the polishing pad comprising a plurality of porogen-features.

9. The method of claim 8, wherein the curable porogen-forming composition, further comprises:
(D) from about 10 wt. % to about 20 wt. % of polyvinylpyrrolidone.

10. The composition of claim 8, wherein the acrylamide monomer compound is 4-acryloylmorpholine.

11. The composition of claim 8, wherein the acrylamide monomer compound is N,N-dimethylacrylamide.

12. The method of claim 8, wherein the polyhydroxy compound having two or more hydroxyl groups is a water-soluble polyhydroxy compound which does not possess any curable functional groups.

13. The method of claim 8, wherein the polyhydroxy compound having two or more hydroxyl groups has a molecular weight in a range from about 400 g/mol to about 1000 g/mol.

14. The method of claim 8, wherein the curable porogen-forming composition further comprises from about 70 wt. % to about 80 wt. % of the acrylamide monomer compound and from about 10 wt. % to about 20 wt. % of the polyhydroxy compound having two or more hydroxyl groups.

15. A polishing pad, comprising:
a plurality of polishing elements, each comprising:
an individual surface that forms a portion of a polishing surface of a polishing pad; and
one or more sidewalls extending downward from the individual surface to define a plurality of channels disposed between the polishing elements, wherein:
each of the polishing elements has a plurality of porogen-features formed of a curable porogen-forming composition, the curable porogen-forming composition comprising:
(A) from about 60 to about 80 wt. % of an acrylamide monomer compound selected from 4-acryloylmorpholine, N, N-dimethylacrylamide, or a combination thereof;
(B) from about 10 to about 40 wt. % of a polyhydroxy compound having two or more hydroxyl groups; and
(C) from about 0.2 wt. % to about 4 wt. % of a photoinitiator component.

16. The polishing pad of claim 15, wherein the curable porogen-forming composition further comprises:
(D) from about 10 wt. % to about 20 wt. % of polyvinylpyrrolidone.

17. The polishing pad of claim 15, wherein the acrylamide monomer compound is 4-acryloylmorpholine.

18. The polishing pad of claim 15, wherein the acrylamide monomer compound is N, N-dimethylacrylamide.

19. The polishing pad of claim 15, wherein the polyhydroxy compound having two or more hydroxyl groups is a water-soluble polyhydroxy compound which does not possess any curable functional groups.

20. The polishing pad of claim 15, wherein the polyhydroxy compound having two or more hydroxyl groups has a molecular weight in a range from about 400 g/mol to about 1000 g/mol.
